(19) United States
(12) Patent Application Publication
(10) Pub. No.: US 2018/0025819 A1
(43) Pub. Date: Jan. 25, 2018

(54) METHOD FOR PRODUCING R-T-B SYSTEM SINTERED MAGNET

(71) Applicant: HITACHI METALS, LTD., Minato-ku, Tokyo (JP)

(72) Inventors: Yasutaka SHIGEMOTO, Mishima-gun (JP); Takeshi NISHIUCHI, Mishima-gun (JP); Futoshi KUNIYOSHI, Mishima-gun (JP); Noriyuki NOZAWA, Mishima-gun (JP)

(73) Assignee: HITACHI METALS, LTD., Minato-ku, Tokyo (JP)

(21) Appl. No.: 15/550,818

(22) PCT Filed: Feb. 16, 2016
(86) PCT No.: PCT/JP2016/054398

§ 371 Date: Aug. 14, 2017

(30) Foreign Application Priority Data
Feb. 18, 2015 (JP) 2015-029204
Jun. 4, 2015 (JP) 2015-113567
Jul. 30, 2015 (JP) 2015-150586

(51) Int. Cl. H01F 1/057; B22F 1/00; C22C 28/00; H01F 41/02; C22C 38/06; C22C 38/02; C22C 38/04; B22F 3/24; C22C 38/00

(52) U.S. Cl. CPC H01F 1/0577; B22F 3/24; B22F 1/0011; C22C 28/00; C22C 38/005; C22C 38/06; C22C 38/02; C22C 38/04; H01F 41/0266

(57) ABSTRACT

A step of providing an R1-T1-X (where R1 is mainly Nd; T1 is mainly Fe; and X is mainly B) based sintered alloy compact mainly characterized by a molar ratio of [T1]/[X] being 13.0 or more; a step or providing an R2-Ga—Cu (where R2 is mainly Pr and/or Nd and accounts for not less than 65 mol % and not more than 95 mol %; and [Cu]/([Ga]+[Cu]) is not less than 0.1 and not more than 0.9 by mole ratio) based alloy; and a step of, while allowing at least a portion of a surface of the R1-T1-X based sintered alloy compact to be in contact with at least a portion of the R2-Ga—Cu based alloy, performing a heat treatment at a temperature which is not less than 450° C. and not more than 600° C.

### TECHNICAL FIELD

The present invention relates to a method for producing a sintered R-T-B based magnet.

### BACKGROUND ART

Sintered R-T-B based magnets (where R is at least one rare-earth element which always includes Nd; T is at least one transition metal element which always includes Fe; and B is boron) are known as permanent magnets with the highest performance, and are used in voice coil motors (VCM) of hard disk drives, various types of motors such as motors for electric vehicles (EV, HV, PHV, etc.) and motors for industrial equipment, home appliance products, and the like.

A sintered R-T-B based magnet is composed of a main phase which mainly consists of an R2T₁₄B compound and a grain boundary phase (which hereinafter may be simply referred to as the “grain boundaries”) that is at the grain boundaries of the main phase. The R₂T₁₄B compound is a ferromagnetic phase having high magnetization, and provides a basis for the properties of a sintered R-T-B based magnet.

Coercivity H_{cJ} (which hereinafter may be simply referred to as “coercivity” or as “H_{cJ}”) of sintered R-T-B based magnets decreases at high temperatures, thus causing an irreversible flux loss. For this reason, sintered R-T-B based magnets for use in motors for electric vehicles, in particular, are required to have high H_{cJ} at high temperatures, i.e., to have higher H_{cJ} at room temperature.

It is known that H_{cJ} is improved if a light rare-earth element (mainly Nd and/or Pr) contained in the R of the R₂T₁₄B compound of a sintered R-T-B based magnet is partially replaced with a heavy rare-earth element (mainly Dy and/or Tb). H_{cJ} is more improved as the amount of substituted heavy rare-earth element increases.

However, replacing the light rare-earth element RL in the R2T₁₄B compound with a heavy rare-earth element may improve the H_{cJ} of the sintered R-T-B based magnet, but decrease its remanence Bᵣ (which hereinafter may be simply referred to as “Bᵣ”). Moreover, heavy rare-earth elements, in particular Dy and the like, are scarce resource, and they yield only in limited regions. For this and other reasons, they have problems of instable supply, significantly fluctuating prices, and so on. Therefore, the recent years have seen the users' desire for improved H_{cJ} while using as little heavy rare-earth element as possible, without lowering Br.

Patent Document 1 discloses, while an R¹ᵢ-M¹ⱼ alloy (15<j≦99) of a specific composition containing an intermetallic compound phase in an amount of 70 vol % or more is allowed to be present on the surface of a sintered compact of a specific composition, performing a heat treatment for 1 minute to 30 hours in a vacuum or an inert gas, at a temperature which is equal to or less than the sintering temperature of the sintered compact. One element or two or more elements of the R¹ and M¹ contained in the alloy diffuse into the grain boundary portions inside the aforementioned sintered compact and/or into the main phase in the vicinity of the grain boundary portions. As specific examples, Patent Document 1 discloses performing a diffusion heat treatment at 800° C. for 1 hour, while allowing an Nd₃₃Al₆₇ alloy containing an NdAl₂ phase or an Nd₃₅Fe₂₅Co₂₀Al₂₀ alloy containing an Nd(Fe,Co,Al)₂ phase or the like to be in contact with a sintered compact of Nd₁₆Fe_{ba1}.Co_{1.0}B_{5.3}.

Patent Document 2 discloses a method in which an Nd—Fe—B based sintered compact and a source containing Pr are placed in a container and heated, whereby Pr is supplied to the magnet interior. It is disclosed that, by optimizing conditions in the method of Patent Document 2, Pr is allowed to be present only at the grain boundaries while restraining Pr from being introduced into the main phase crystal grains, thereby improving coercivity not only at room temperature but also at high temperatures (e.g., 140° C.). As a specific example, Patent Document 2 discloses heating at 660° C. to 760° C. by using an appropriate amount of Pr metal powder.

Patent Document 3 discloses allowing an RE-M alloy which contains an M element (specifically, Ga, Mn, In) having a specific vapor pressure and whose melting point is equal to or less than 800° C. to be in contact with an RE-T-B based sintered compact, and performing a heat treatment at a temperature which is 50 to 200° C. higher than the vapor pressure curve of the M element. Through this heat treatment, the RE element permeates the compact via diffusion from the melt of the RE-M alloy. Patent Document 3 states that, as the M element evaporates during the process, it is restrained from being introduced to the magnet interior, whereby only the RE element is efficiently introduced. As a specific example, Patent Document 3 discloses using an Nd-20 at % Ga and performing a heat treatment at 850° C. for 15 hours.

### CITATION LIST

### Patent Literature

[Patent Document 1] Japanese Laid-Open Patent Publication No. 2008-263179

[Patent Document 2] Japanese Laid-Open Patent Publication No. 2014-112624

[Patent Document 3] Japanese Laid-Open Patent Publication No. 2014-086529

### SUMMARY OF INVENTION

### Technical Problem

The methods described in Patent Documents 1 to 3 are worth attention in that they are able to improve the coercivity of a sintered R-T-B based magnet without using any heavy rare-earth elements at all. However, in any of the above, it is only the vicinity of the magnet surface that is improved in coercivity, while there is hardly any coercivity improvement in the magnet interior. As is described in Patent Document 3, the grain boundaries (in particular, any grain boundary that exists between two main phase portions; which may hereinafter be referred to as “intergranular grain boundaries”) drastically decrease in thickness, away from the magnet surface and toward the magnet interior, and this causes a large difference in coercivity between the vicinity of the magnet surface and the magnet interior. There is a problem in that, if the portion with improved coercivity is removed through a surface grinding or the like that is performed for adjusting the magnet dimensions in the generic magnet production steps, the coercivity improvement effects are significantly undermined.

Various embodiments of the present invention provide methods for producing a sintered R-T-B based magnet in which the intergranular grain boundaries can be made thick not only in the vicinity of the magnet surface but also in the magnet interior, such that coercivity improvement effects are not significantly undermined even after a surface grinding for adjusting the magnet dimensions, and which provides high coercivity without using a heavy rare-earth element.

### Solution to Problem

A method for producing a sintered R-T-B based magnet according to the present invention is a method for producing a sintered R-T-B (where R is at least one rare-earth element which always includes Nd; T is at least one transition metal element which always includes Fe; and B is partially replaceable with C) based magnet, comprising: a step of providing an R1-T1-X (where R1 is at least one rare-earth element which always includes Nd and accounts for not less than 27 mass % and not more than 35 mass %; T1 is Fe, or Fe and M; M is one or more selected from among Ga, Al, Si, Ti, V, Cr, Mn, Co, Ni, Cu, Zn, Ge, Zr, Nb, Mo and Ag; X is B, where B is partially replaceable by C; and a molar ratio of [T1]/[X] is not less than 13.0) based sintered alloy compact; a step of providing an R2-Ga—Cu (where R2 is at least one rare-earth element which always includes Pr and/or Nd and accounts for not less than 65 mol % and not more than 95 mol %; and [Cu]/([Ga]+[Cu]) is not less than 0.1 and not more than 0.9 by mole ratio) based alloy; and a step of, while allowing at least a portion of the R2-Ga—Cu based alloy to be in contact with at least a portion of a surface of the R1-T1-X based sintered alloy compact, performing a heat treatment at a temperature which is not less than 450° C. and not greater than 600° C. in a vacuum or an inert gas ambient.

In one embodiment, T1 in the R1-T1-X comprises Fe and M, where M is one or more selected from the group consisting of Al, Si, Ti, V, Cr, Mn, Co, Ni, Cu, Zn, Ge, Zr, Nb, Mo and Ag.

In one embodiment, a molar ratio of [T1]/[X] in the R1-T1-X based sintered alloy compact is 13.6 or more.

In one embodiment, a molar ratio of [T1]/[X] in the R1-T1-X based sintered alloy compact is 14 or more.

In one embodiment, any heavy rare-earth element accounts for 1 mass % or less of the R1-T1-X based sintered alloy compact.

In one embodiment, the step of providing an R1-T1-X based sintered alloy compact comprises pulverizing a raw material alloy to a size of not less than 1 μm and not more than 10 μm, thereafter pressing the pulverized raw material alloy in a magnetic field, and performing sintering.

In one embodiment, the step of providing an R1-T1-X based sintered alloy compact comprises, after the sintering, performing a high-temperature heat treatment at a temperature which is above 600° C. and below a sintering temperature.

In one embodiment, the R2-Ga—Cu based alloy does not contain any heavy rare-earth element.

In one embodiment, Pr accounts for 50 mol % or more of the R2 in the R2-Ga—Cu based alloy.

In one embodiment, the R2 in the R2-Ga—Cu based alloy consists only of Pr (while allowing inevitable impurities).

In one embodiment, some of the R2 in the R2-Ga—Cu based alloy is a heavy rare-earth element, the heavy rare-earth element being contained in an amount of 10 mol % or less of the entire R2-Ga—Cu based alloy.

In one embodiment, some of the R2 in the R2-Ga—Cu based alloy is a heavy rare-earth element, the heavy rare-earth element being contained in an amount of 5 mol % or less of the entire R2-Ga—Cu based alloy.

In one embodiment, in the R2-Ga—Cu based alloy, some of the R2 is a heavy rare-earth element, and Pr accounts for 50 mol % or more of the entire R2 excluding the heavy rare-earth element.

In one embodiment, in the R2-Ga—Cu based alloy, some of the R2 is a heavy rare-earth element, and Pr accounts for the entire R2 excluding the heavy rare-earth element (disregarding inevitable impurities).

In one embodiment, the temperature in the step of performing a heat treatment is not less than 480° C. and not more than 540° C.

In one embodiment, in the step of performing a heat treatment, an R1₂T1₁₄X phase in the R1-T1-X based sintered alloy compact reacts with a liquid phase occurring from the R2-Ga—Cu based alloy to generate an R6T13Z phase (where Z always includes Ga and/or Cu) at least partially inside the sintered magnet.

In one embodiment, the step of performing a heat treatment comprises applying and/or spreading a powder of the R2-Ga—Cu based alloy on at least a portion of the surface of the R1-T1-X based sintered alloy compact to place the R2-Ga—Cu based alloy in contact with at least a portion of the surface of the R1-T1-X based sintered alloy compact.

In one embodiment, the powder of the R2-Ga—Cu based alloy to be spread and/or applied on the surface of the R1-T1-X based sintered alloy compact is in an amount of not less than 0.2 parts by mass and not more than 0.5 parts by mass, relative to 100 parts by mass of the R1-T1-X based sintered alloy compact.

### Advantageous Effects of Invention

According to the present invention, there is provided a method for producing a sintered R-T-B based magnet in which the intergranular grain boundaries can be made thick not only in the vicinity of the magnet surface but also in the magnet interior, such that coercivity improvement effects are not significantly undermined even after a surface grinding for adjusting the magnet dimensions, and which provides high coercivity without using a heavy rare-earth element.

### BRIEF DESCRIPTION OF DRAWINGS

FIG. 1A A partially enlarged cross-sectional view schematically showing a sintered R-T-B based magnet.

FIG. 1B A further enlarged cross-sectional view schematically showing the interior of a broken-lined rectangular region in FIG. 1A.

FIG. 2 An explanatory diagram schematically showing how an R1-T1-X based sintered alloy compact and an R2-Ga—Cu based alloy may be placed during a heat treatment step.

FIG. 3 A photograph showing the vicinity of the magnet surface of Sample No. 6-1 as observed with a scanning electron microscope.

FIG. 4 A photograph showing the magnet central portion of Sample No. 6-1 as observed with a scanning electron microscope.

FIG. 5 A photograph showing the vicinity of the magnet surface of Sample No. 9-1 as observed with a scanning electron microscope.

FIG. 6 A photograph showing the magnet central portion of Sample No. 9-1 as observed with a scanning electron microscope.

### DESCRIPTION OF EMBODIMENTS

In the methods described in Patent Documents 1 and 2, a relatively high temperature, typically a temperature of 650° C. or above, has been adopted for the heat treatment. This is presumably because part of the grain boundaries existing between main phase portions of the sintered compact melts at a temperature of 650° C. or above, such that elements are introduced from the exterior through this region as a diffusion path. In other words, it is considered that the need to secure a certain amount of liquid phase in the sintered compact has made it effective to perform a relatively high-temperature treatment.

On the other hand, in the method described in Patent Document 3, Ga or the like is used to lower the melting point of the rare-earth alloy serving as a diffusion source, and, by utilizing the vapor pressure of Ga, a rare-earth element (which in Patent Document 3 is Nd) is introduced to the interior of the sintered compact, while restraining Ga from being introduced to the interior of the sintered compact. As a result of this, thick intergranular grain boundaries can be created even at a relatively low heat treatment temperature, whereby coercivity can be improved. However, in the method of Patent Document 3, it is only in the vicinity of the magnet surface that thick intergranular grain boundaries are created, and the intergranular grain boundaries in the magnet interior remain thin.

Through vigorous studies aimed at solving the above problems, the present inventors have arrived at a method which performs a heat treatment at a relatively low temperature while an R2-Ga—Cu based alloy of a specific composition such that [Cu]/([Ga]+[Cu]) is not less than 0.1 and not more than 0.9 by mole ratio is allowed to be in contact with a sintered alloy compact of a composition (a molar ratio of [T]/[B] is 14 or more) which is richer in T and poorer in B (or a total of B and C, in the case where B is partially replaced by C) than R2T₁₄B, i.e., the stoichiometric composition of the main phase of a commonly-available sintered R-T-B based magnet. With this method, a liquid phase that occurs from the R2-Ga—Cu based alloy can be introduced from the surface of the sintered compact to the interior through diffusion, via grain boundaries in the sintered compact. It has been further found that thick intergranular grain boundaries containing Ga and/or Cu can be easily formed all the way into the interior of the sintered compact. By creating such a structure, magnetic coupling between main phase crystal grains is greatly alleviated, whereby a sintered R-T-B based magnet with a very high coercivity can be obtained without using a heavy rare-earth element. Upon further studies based on these findings, it has been found that, even when a molar ratio of [T1]/[X] in the sintered alloy compact is 13.0 or more but less than 14, a high coercivity is exhibited which is close to that of a sintered R-T-B based magnet being produced by using a sintered alloy compact in which a molar ratio of [T1]/[X] is 14 or more.

First, prior to describing embodiments of methods for producing sintered R-T-B based magnet, the fundamental structure of a sintered R-T-B based magnet will be described.

The sintered R-T-B based magnet has a structure such that powder particles of a raw material alloy have bound together through sintering, and is composed of a main phase which mainly consists of an R₂T₁₄B compound and a grain boundary phase which is at the grain boundaries of the main phase.

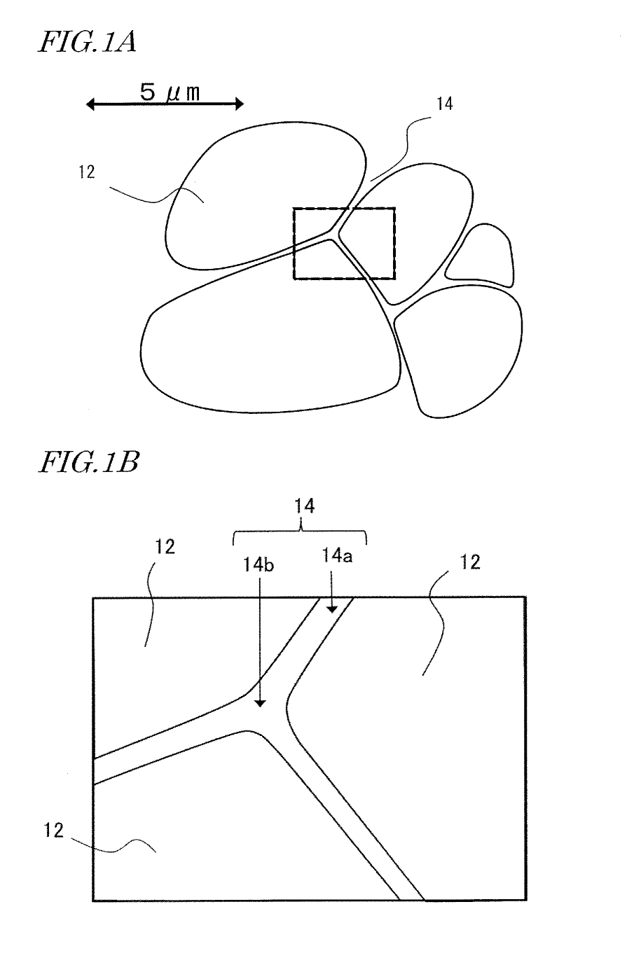

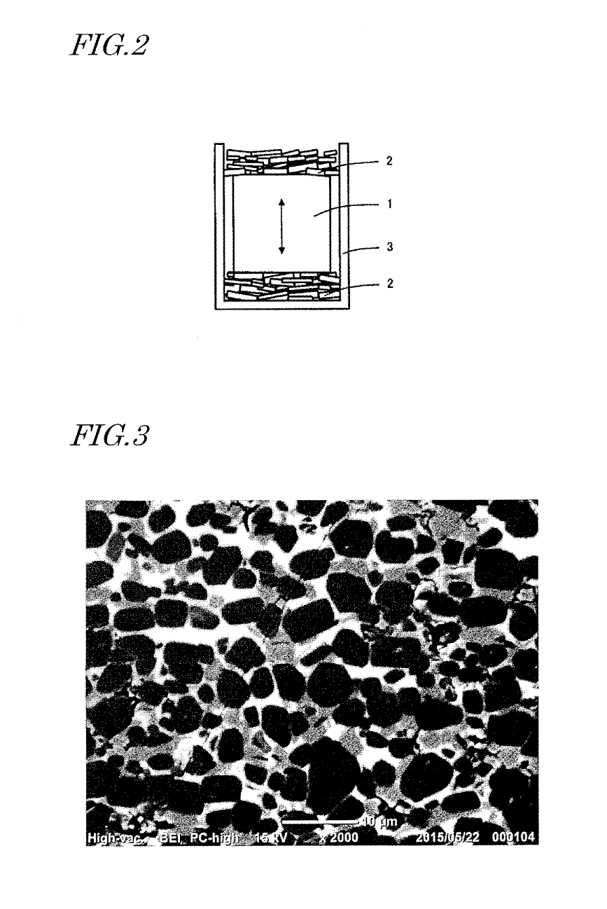

FIG. 1A is a partially enlarged cross-sectional view schematically showing a sintered R-T-B based magnet. FIG. 1B is a further enlarged cross-sectional view schematically showing the interior of a broken-lined rectangular region in FIG. 1A. In FIG. 1A, arrowheads indicating a length of 5 μm are shown as an example of reference length to represent size. As shown in FIG. 1A and FIG. 1B, the sintered R-T-B based magnet is composed of a main phase which mainly consists of an R₂T₁₄B compound 12 and a grain boundary phase 14 which is at the grain boundaries of the main phase 12. Moreover, as shown in FIG. 1B, the grain boundary phase 14 includes an intergranular grain boundary phase 14a in which two R2T₁₄B compound grains adjoining each other, and grain boundary triple junctions 14b at which three R2T₁₄B compound grains adjoin one another.

The main phase 12, i.e., the R₂T₁₄B compound, is a ferromagnetic material having high saturation magnetization and an anisotropy field. Therefore, in a sintered R-T-B based magnet, it is possible to improve Bᵣ by increasing the abundance ratio of the R₂T₁₄B compound which is the main phase 12. In order to increase the abundance ratio of the R₂T₁₄B compound, the R amount, the T amount, and the B amount in the raw material alloy may be brought closer to the stoichiometric ratio of the R₂T₁₄B compound (i.e., the R amount:the T amount:the B amount=2:14:1). When the B amount or the R amount belonging in the R₂T₁₄B compound falls lower than the stoichiometric ratio, generally speaking, small pieces of magnetic substance of anisotropy fields such as an Fe phase or an R₂T₁₇ phase occurs in the grain boundary phase 14, whereby H_{cJ} is drastically decreased.

Hereinafter, non-limiting and illustrative embodiments of the present disclosure will be described.

(1) Step of Providing an R1-T1-X Based Sintered Alloy Compact

In a step of providing an R1-T1-X based sintered alloy compact (which may hereinafter be simply referred to as a “sintered compact”), the sintered compact has a composition such that: R1 is at least one rare-earth element which always includes Nd and accounts for not less than 27 mass % and not more than 35 mass %; T1 is Fe, or Fe and M; M is one or more selected from among Ga, Al, Si, Ti, V, Cr, Mn, Co, Ni, Cu, Zn, Ge, Zr, Nb, Mo and Ag; X is B, where B is partially replaceable by C; a molar ratio of [T1]/[X] is 13.0 or more, preferably 13.6 or more, and more preferably 14 or more.

R1 is at least one rare-earth element which always includes Nd. Besides Nd, another example of a rare-earth element may be Pr, for example. Furthermore, heavy rare-earth elements such as Dy, Tb, Gd and Ho, which are commonly used in order to improve the coercivity of a sintered R-T-B based magnet, may be contained in small amounts. However, the present invention makes it possible to obtain a sufficiently high coercivity without using the aforementioned heavy rare-earth element(s) in large amounts. Therefore, preferably, the heavy rare-earth element(s) is contained in an amount which is 1 mass % or less, or more preferably 0.5 mass % or less, of the entire R1-T1-X based sintered alloy compact (i.e., the heavy rare-earth element accounts for 1 mass % or less in the R1-T1-X based sintered alloy compact), and still more preferably, no heavy rare-earth element is contained (i.e., substantially 0 mass %).

It is preferable that R1 accounts for not less than 27 mass % and not more than 35 mass % of the entire R1-T1-X based sintered alloy compact. If R1 is less than 27 mass %, a liquid phase will not sufficiently occur in the sintering process, and it will be difficult for the sintered compact to become adequately dense in texture. On the other hand, if R1 exceeds 35.0 mass %, effects of the present invention will be obtained, but the alloy powder during the production steps of the sintered compact will be very active, and considerable oxidization, ignition, etc. of the alloy powder may possibly occur; therefore, it is preferably 35 mass % or less. More preferably, R1 is not less than 28 mass % and not more than 33 mass %; and still more preferably, R1 is not less than 28.5 mass % and not more than 32 mass %.

T1 is Fe, or Fe and M; and M is one or more selected from among Ga, Al, Si, Ti, V, Cr, Mn, Co, Ni, Cu, Zn, Ge, Zr, Nb, Mo and Ag. In other words, T1 may be Fe alone (although inevitable impurities may be included), or consist of Fe and M (although inevitable impurities may be included). When T1 consists of Fe and M, it is preferable that the Fe amount accounts for 80 mol % or more in the entire Ti. When T1 consists of Fe and M, M may be one or more selected from among Al, Si, Ti, V, Cr, Mn, Co, Ni, Cu, Zn, Ge, Zr, Nb, Mo and Ag.

X is B, where B is partially replaceable by C (carbon). In the case where B is partially replaced by C, it may not only be what is purposely added during the production steps of the sintered compact, but may also include any solid or liquid lubricant that is used during the production steps of the sintered compact, and what originates in the dispersion medium or the like (in the case of wet forming) and remains in the sintered compact. The C that originates from a lubricant, a dispersion medium, etc. is inevitable, but it can still be controlled to within a certain range (i.e., adjustment of added amounts or a decarbonization treatment); therefore, by taking these amounts into consideration, the B amount and the C amount to be purposely added may be prescribed so as to satisfy the below-described relationship between T1 and X. In order to purposely add C during the production steps of the sintered compact, for example, C may be added as a raw material when producing the raw material alloy (i.e., a raw material alloy containing C may be produced); a C source (carbon source), e.g., a specific amount of carbon black, may be added to the alloy powder during the production steps (i.e., a coarse-pulverized powder existing before the below-described pulverization with a jet mill or the like, or a fine-pulverized powder existing after the pulverization); and so on. Note that B accounts for preferably 80 mol % or more, and more preferably 90 mol % or more, of the entire X. Moreover, X preferably accounts for not less than 0.8 mass % and not more than 1.0 mass % of the entire R1-T1-X based sintered alloy compact. When X is less than 0.8 mass %, effects of the present invention will still be obtained, but Bᵣ will be greatly reduced, which is not preferable. On the other hand, when X exceeds 1.0 mass %, the molar ratio of [T1]/[X] as described below cannot be made equal to or greater than 13.0 and the effects of the present invention will not be achieved, which is not preferable. More preferably, X accounts for not less than 0.83 mass % and not more than 0.98 mass %, and still more preferably, not less than 0.85 mass % and not more than 0.95 mass %.

The aforementioned T1 and X are prescribed so that a molar ratio of [T1]/[X] is 14 or more. This condition indicates a molar ratio similar to that of [T]/[B] (=14) in R₂T₁₄B, i.e., the stoichiometric composition of the main phase of a commonly-available sintered R-T-B based magnet, or being richer in T and poorer in B than that. As described above, the inventors had believed at the outset of the invention that, when the molar ratio of [T1]/[X] was less than 14, as in the composition of a commonly-available sintered R-T-B based magnet (i.e., poorer in T and richer in B than the molar ratio of [T]/[B] in the stoichiometric composition R₂T₁₄B), the intergranular grain boundaries in the vicinity of the magnet surface and in the magnet interior could not be made thick in the sintered R-T-B based magnet to be finally obtained, and thus it would be difficult to obtain a sintered R-T-B based magnet with high coercivity without the use of heavy rare-earth elements. However, they found in further studies that, even when poorer in T and richer in B than the molar ratio of [T]/[B] in R₂T₁₄B, i.e., the stoichiometric composition of the main phase of a commonly-available sintered R-T-B based magnet, a molar ratio of [T1]/[X] that is 13.0 or more can still provide a coercivity which, if not exceeding what will be obtained by using a sintered alloy compact of 14 or greater, comes very close to it.

In other words, the molar ratio of [T1]/[X] being set to 14 or more is based on the notion that the B and C composing X will entirely be consumed in making the main phase. Generally speaking, however, X (in particular, C) will not entirely be consumed in the main phase formation, but will also be present in the grain boundary phase. Thus it has been found that, in actuality, [X] may be set slightly greater (i.e., poorer in T and richer in B); that is, the molar ratio of [T1]/[X] may be set 13.0 or more, and high coercivity can still be obtained. It is difficult to determine an accurate ratio by which X is distributed between the main phase and the grain boundary phase; however, when the molar ratio of [T1]/[X] is 13.0 or more, given that the X which is being consumed in the main phase formation has a molar ratio of [X′] (where [X′]≦[X]), it is considered that [T1]/[X′] is 14 or more. If the molar ratio of [T1]/[X] is less than 13.0, the aforementioned [T1]/[X′] may not be made 14 or more, in which case the intergranular grain boundaries in the vicinity of the magnet surface and in the magnet interior cannot be made thick in the sintered R-T-B based magnet that is finally obtained, thus making it difficult to obtain a sintered R-T-B based magnet with high coercivity without the use of heavy rare-earth elements. While the molar ratio of [T1]/[X] being 13.0 or more provides high coercivity as described above, in order to attain even higher coercivity and to stably attain high coercivity in a mass production process, the molar ratio of [T1]/[X] is preferably 13.6, more preferably 13.8 or more, and still more preferably 14 or more.

An R1-T1-X based sintered alloy compact can be provided by using a generic method for producing a sintered R-T-B based magnet, such as an Nd—Fe—B based sintered magnet. As one example, a raw material alloy which is produced by a strip casting method or the like may be pulverized to not less than 1 μm and not more than 10 μm by using a jet mill or the like, thereafter pressed in a magnetic field, and then sintered at a temperature of not less than 900° C. and not more than 1100° C. In the resultant sintered compact, it does not matter if the coercivity is very low. If the pulverized particle size (having a central value of volume as obtained by an airflow-dispersion laser diffraction method=D50) of the raw material alloy is less than 1 μm, it becomes very difficult to produce pulverized powder, thus resulting in a greatly reduced production efficiency, which is not preferable. On the other hand, if the pulverized particle size exceeds 10 μm, the sintered R-T-B based magnet as finally obtained will have too large a crystal grain size to achieve high coercivity, which is not preferable, even though thick intergranular grain boundaries may be formed.

So long as the aforementioned conditions are satisfied, the R1-T1-X based sintered alloy compact may be produced from one kind of raw material alloy (a single raw-material alloy), or through a method of using two or more kinds of raw material alloys and mixing them (blend method) Moreover, the R1-T1-X based sintered compact may contain inevitable impurities, such as O (oxygen), N (nitrogen), and C (carbon), that may exist in the raw material alloy or introduced during the production steps.

Moreover, in providing the R1-T1-X based sintered alloy compact, after the sintering, a high-temperature heat treatment may further be performed at a temperature which is above 600° C. and below the sintering temperature. Performing a high-temperature heat treatment at such a temperature may allow the magnetic characteristics of the final sintered R-T-X based magnet to be further improved in some cases. Performing a heat treatment at a temperature which is below 600° C. for the R1-T1-X based sintered alloy compact alone would only result in the number of steps being increased, without contributing to further property improvement of the final sintered R-T-X based magnet; the reason is that this sintered compact will subsequently be subjected to a heat treatment at a temperature which is 600° C. or below, while being in contact with the R2-Ga—Cu based alloy. On the other hand, if the temperature of the high-temperature heat treatment is above the sintering temperature, abnormal grain growth may become evident, thereby lowering the coercivity of the finally-obtained sintered R-T-X based magnet, or degrading the squareness of its demagnetization curve.

Especially when at least one of Si, Ga, Al, Zn and Ag is contained in an amount of 0.1 mass % or more as an M element in the T1 of the R1-T1-X based sintered alloy compact, it is preferable to perform the aforementioned high-temperature heat treatment at a temperature which is not less than 700° C. and not more than 1000° C. When any such M element is contained, an R1-T1-M phase (e.g., an R₆Fe₁₃Ga phase) may occur in the sintered compact during a cooling process after the sintering, so that, when performing a heat treatment at a temperature of 600° C. or below while placing the R2-Ga—Cu based alloy in contact, a liquid phase which has occurred from the R2-Ga—Cu based alloy may be introduced from the surface of the sintered compact to the interior through diffusion, via grain boundaries in the sintered compact. Such a high-temperature heat treatment is particularly effective when the sintered compact contains Ga.

(2) Step of Providing an R2-Ga—Cu Based Alloy

In a step of providing an R2-Ga—Cu based alloy, the R2-Ga—Cu based alloy has a composition such that: R2 is at least one rare-earth element which always includes Pr and/or Nd and accounts for not less than 65 mol % and not more than 95 mol %; and [Cu]/([Ga]+[Cu]) is not less than 0.1 and not more than 0.9 by mole ratio. The R2-Ga—Cu based alloy always contains both Ga and Cu. If not both of Ga and Cu are contained, the intergranular grain boundaries in the vicinity of the magnet surface and in the magnet interior cannot be made thick in the sintered R-T-B based magnet that is finally obtained, thus making it difficult to obtain a sintered R-T-B based magnet with high coercivity without the use of heavy rare-earth elements.

R2 is at least one rare-earth element which always includes Pr and/or Nd. Herein, it is preferable that 90 mol % or more of the entire R2 is Pr and/or Nd, more preferable that 50 mol % or more of the entire R2 is Pr, and still more preferable that R2 is Pr alone (although inevitable impurities may be included). R2 may contain small amounts of heavy rare-earth elements such as Dy, Tb, Gd and Ho, which are commonly used in order to improve the coercivity of a sintered R-T-B based magnet. However, according to the present invention, a sufficiently high coercivity can be obtained without using the aforementioned heavy rare-earth element(s) in large amounts. Therefore, the aforementioned heavy rare-earth element(s) is contained in an amount which is preferably 10 mol % or less of the entire R2-Ga—Cu based alloy (i.e., the heavy rare-earth element(s) accounts for 10 mol % or less in the R2-Ga—Cu based alloy), more preferably 5 mol % or less, and still more preferably not contained at all (substantially 0 mol %). When the R2 of the R2-Ga—Cu based alloy contains the aforementioned heavy rare-earth element(s), it is preferable that 50 mol % or more of the entire R2 excluding the heavy rare-earth element(s) is Pr, and more preferable that the R2 excluding the heavy rare-earth element(s) is Pr alone (although inevitable impurities may be included).

When R2 accounts for not less than 65 mol % and not more than 95 mol % of the entire R2-Ga—Cu based alloy and [Cu]/([Ga]+[Cu]) is not less than 0.1 and not more than 0.9 by mole ratio, there is provided a sintered R-T-B based magnet in which the intergranular grain boundaries can be made thick not only in the vicinity of the magnet surface but also in the magnet interior, such that coercivity improvement effects are not significantly undermined even after a surface grinding for adjusting the magnet dimensions, and which provides high coercivity without using a heavy rare-earth element. More preferably, R2 accounts for not less than 70 mol % and not more than 90 mol % of the entire R2-Ga—Cu based alloy, and still more preferably not less than 70 mol % and not more than 85 mol %. Moreover, [Cu]/([Ga]+[Cu]) is more preferably not less than 0.2 and not more than 0.8 by mole ratio, and still more preferably not less than 0.3 and not more than 0.7.

The R2-Ga—Cu based alloy may contain small amounts of Al, Si, Ti, V, Cr, Mn, Co, Ni, Zn, Ge, Zr, Nb, Mo, Ag, and the like. A small amount of Fe may be contained, and effects of the present invention can still be obtained when Fe is contained in an amount of 20 mass % or less. However, if the Fe content exceeds 20 mass %, coercivity may be lowered. Moreover, inevitable impurities such as O (oxygen), N (nitrogen), C (carbon), and the like may be contained.

The R2-Ga—Cu based alloy can be provided by a method of producing a raw material alloy that is adopted in generic methods for producing a sintered R-T-B based magnet, e.g., a mold casting method, a strip casting method, a single roll rapid quenching method (a melt spinning method), an atomizing method, or the like. Moreover, the R2-Ga—Cu based alloy may be what is obtained by pulverizing an alloy obtained as above with a known pulverization means such as a pin mill.

(3) Step of Heat Treatment

While at least a portion of the R2-Ga—Cu based alloy that has been provided as above is allowed to be in contact with at least a portion of the surface of the R1-T1-X based sintered alloy compact that has been provided as above, a heat treatment is performed in a vacuum or an inert gas ambient, at a temperature which is not less than 450° C. and not greater than 600° C. As a result, a liquid phase occurs from the R2-Ga—Cu based alloy, and this liquid phase is introduced from the surface of the sintered compact to the interior through diffusion via grain boundaries in the sintered compact, so that thick intergranular grain boundaries containing Ga and Cu can be easily formed all the way into the interior of the sintered compact between crystal grains of the main phase, i.e., the R1₂T1₁₄X phase, whereby magnetic coupling main phase crystal grains is greatly alleviated. As a result, a sintered R-T-B based magnet with a very high coercivity can be obtained without the use of heavy rare-earth elements. The temperature at which to conduct the heat treatment is preferably not less than 480° C. and not more than 540° C. A higher coercivity can be attained.

Generally speaking, a region of about 200 μm is removed off the surface of the sintered compact when surface grinding for adjustment of magnet dimensions is performed. Therefore, effects of the present invention can be obtained when there is a region in which thick intergranular grain boundaries exist to about 250 μm from the surface of the R1-T1-X based sintered alloy compact. However, in such a case (thick intergranular grain boundaries exist to about 250 μm), H_{cJ} in the neighborhood of the center of the R-T-X based sintered compact is not sufficiently improved after the heat treatment, so that squareness of the demagnetization curve may be degraded. Therefore, regarding H_{cJ} in the neighborhood of the center of the R1-T1-X based sintered alloy compact, it is preferable that H_{cJ}≧1200 kA/m, and more preferable that H_{cJ}≧1360 kA/m, when a heat treatment is performed at a temperature which is not less than 450° C. and not more than 600° C. without the R2-Ga—Cu based alloy being in contact (i.e., a usual heat treatment for improving coercivity of the sintered R-T-B based magnet). Use of such a sintered compact allows the overall magnet to attain high H_{cJ} and good squareness of the demagnetization curve even though the introduced amount of the R2-Ga—Cu alloy is small, so that high Bᵣ and high H_{cJ} can be easily reconciled.

Regarding H_{cJ} in the neighborhood of the center of the R1-T1-X based sintered alloy compact, an R1-T1-X based sintered compact that satisfies H_{cJ}≧1200 kA/m when a heat treatment is performed at a temperature which is not less than 450° C. and not more than 600° C. without the R2-Ga—Cu based alloy being in contact can be easily obtained when Ga is contained in T1. The Ga content preferably accounts for not less than 0.05 mass % and not more than 1 mass %, more preferably not less than 0.1 mass % and not more than 0.8 mass %, and still more preferably not less than 0.2 mass % and not more than 0.6 mass %, in the entire R1-T1-X based sintered compact.

In the aforementioned step of heat treatment, the R2-Ga—Cu based alloy alone may be placed in contact with at least a portion of the surface of the R1-T1-X based sintered alloy compact, or methods described in Patent Documents 1 to 3 above may be adopted, e.g., a method which disperses a powder of R2-Ga—Cu based alloy in an organic solvent or the like, and applies this onto the surface of the R1-T1-X based sintered alloy compact; or a method which spreads a powder of R—Ga—Cu based alloy on the surface of the R1-T1-X based sintered alloy compact.

By spreading and/or applying an R2-Ga—Cu based alloy powder on at least a portion of the surface of the R1-T1-X based sintered alloy compact, at least a portion of the R—Ga—Cu based alloy can be more easily placed in contact with at least a portion of the surface of the R1-T1-X based sintered alloy compact.

The amount of liquid phase occurring from the R2-Ga—Cu based alloy that is introduced in the R1-T1-X based sintered alloy compact can be controlled based on the retention temperature and retention time. In the case where the R2-Ga—Cu based alloy is spread and/or applied on the surface of the R1-T1-X based sintered alloy compact, it is preferable to control the spread amount or applied amount. The spread or applied amount of the R2-Ga—Cu based alloy is preferably not less than 0.2 parts by mass and not more than 5.0 parts by mass, and more preferably not less than 0.2 parts by mass and not more than 3.0 parts by mass, relative to 100 parts by mass of the R1-T1-X based sintered alloy compact. Such conditions allow high Bᵣ and high H_{cJ} to be easily reconciled. In the case where the R2-Ga—Cu based alloy is spread or applied on only a portion of the surface of the R1-T1-X based sintered alloy compact, it is preferably spread or applied on a face which is perpendicular to the alignment direction.

The heat treatment involves retaining a temperature which is not less than 450° C. and not more than 600° C., then followed by cooling, in a vacuum or an inert gas ambient. By performing a heat treatment at a temperature which is not less than 450° C. and not more than 600° C., at least a portion of the R2-Ga—Cu based alloy is melted, whereby the generated liquid phase is introduced from the surface of the sintered compact to the interior through diffusion via grain boundaries in the sintered compact, whereby thick intergranular grain boundaries can be formed. If the heat treatment temperature is less than 450° C., no liquid phase occurs at all, so that thick intergranular grain boundaries cannot be obtained. If it exceeds 600° C., it also becomes difficult to form thick intergranular grain boundaries. The heat treatment temperature is more preferably not less than 460° C. and not more than 570° C. The reason why it becomes difficult to form thick intergranular grain boundaries when a heat treatment is performed at a temperature exceeding 600° C. is currently unknown, but presumably at work is the kinetics concerning dissolution of the main phase caused by the liquid phase which is introduced in the sintered compact, and generation of the R6T13Z phase (where R is at least one rare-earth element which always includes Pr and/or Nd; T is at least one transition metal element which always includes Fe; and Z always includes Ga and/or Cu), etc. The heat treatment time may be set to an appropriate value depending on the composition and dimensions of the R1-T1-X based sintered alloy compact, the composition of the R2-Ga—Cu based alloy, the heat treatment temperature, etc., but, it is preferably not less than 5 minutes and not more than 10 hours, more preferably not less than 10 minutes and not more than 7 hours, and still more preferably not less than 30 minutes and not more than 5 hours.

The aforementioned heat treatment temperature of not less than 450° C. and not more than 600° C. is essentially equal to the temperature of a usual heat treatment for improving coercivity of a sintered R-T-B based magnet. Therefore, after performing a heat treatment at a temperature which is not less than 450° C. and not more than 600° C., it is not always required to perform a heat treatment for improving coercivity. Moreover, the heat treatment temperature of not less than 450° C. and not more than 600° C. is a very low temperature as compared to the temperatures of the diffusion heat treatments performed in Patent Documents 1 to 3 above. As a result, the R2-Ga—Cu based alloy component is restrained from diffusing into the interior of the main phase crystal grains. For example, in the case where Pr alone is used for the R2, a heat treatment temperature exceeding 600° C. will easily allow Pr to be introduced to the outermost portion of the main phase crystal grains, this resulting in a problematic decrease of temperature dependence of coercivity. At a heat treatment temperature of not less than 450° C. and not more than 600° C., such problems are greatly suppressed.

The sintered R-T-B based magnet which is obtained through the step of heat treatment may be subjected to known surface treatments, e.g., known machining such as severing or cutting, or plating to confer anticorrosiveness.

There are still unclear aspects of the mechanism by which thick intergranular grain boundaries are formed between crystal grains of the main phase to result in a very high coercivity. Based on the findings which have so far been available, the mechanism as believed by the present inventors will be described below. It must be noted that the following description of the mechanism is not intended to limit the scope of the present invention.

Through detailed studies, the inventors have come to believe that: Cu, by being present in the liquid phase occurring through the heat treatment, lowers the interfacial energy between the main phase and the liquid phase, and thus contributes to efficient introduction of the liquid phase from the surface of the sintered compact to the interior via intergranular grain boundaries; and that, Ga, by being present in the liquid phase which has been introduced in the intergranular grain boundaries, causes the surface vicinity of the main phase to be dissolved, and thus contributes to formation of thick intergranular grain boundaries.

Furthermore, as described earlier, by ensuring that the R1-T1-X based sintered alloy compact has a composition which is richer in T1 and poorer in X than the stoichiometric composition (R1₂T1₁₄X), i.e., the molar ratio of [T1]/[X] is 14 or more, thick intergranular grain boundaries will be easily obtained through the heat treatment. This is presumably because, in the aforementioned composition range, the liquid phase occurring from the R2-Ga—Cu alloy permeates the intergranular grain boundaries in the sintered compact, and the main phase in the vicinity of intergranular grain boundaries in the sintered compact becomes dissolved due to the aforementioned effects of Ga, these easily generating an R₆T₁₃Z phase (Z always includes Ga and/or Cu) at a very low temperature of 600° C. or below and becoming stable; consequently, thick intergranular grain boundaries are maintained even after cooling, thus resulting in a very high coercivity being exhibited. As described earlier, generally speaking, X is not entirely consumed in making the main phase; therefore, so long as [T1]/[X] is 13.0 or more, a thick intergranular grain boundary phase will be successfully formed, and high coercivity will be exhibited.

On the other hand, if the R1-T1-X based sintered alloy compact has a composition which is poorer in T1 and richer in X than the stoichiometric composition (R1₂T1₁₄X), particularly when [T1]/[X] is less than 13.0, thick intergranular grain boundaries will be difficult to be obtained. This is presumably because the main phase (R1₂T1₁₄X phase) which has once dissolved is likely to again precipitate as the main phase, this preventing the grain boundaries from becoming thick.

In the aforementioned R₆T₁₃Z phase (R₆T₁₃Z compound), R is at least one rare-earth element which always includes Pr and/or Nd; T is at least one transition metal element which always includes Fe; and Z always includes Ga and/or Cu. A representative R₆T₁₃Z compound is an Nd₆Fe₁₃Ga compound. Moreover, the R₆T₁₃Z compound has an La₆Co₁₁Ga₃ type crystal structure. Depending on its state, the R₆T₁₃Z compound may have taken the form of an R₆T₁₃₋δZ₁₊5 compound. Even in the case where Z is Ga alone, if Cu, Al and Si are contained in the sintered R-T-B based magnet, it may have taken the form of R₆T₁₃₋δ (Ga_{1-x-y-z}CuₓAl_{y}Si_{z})₁₊6.

### EXAMPLES

The present invention will be described in more detail by way of Examples; however, the present invention is not limited thereto.

### Experimental Example 1

[Providing R1-T1-X Based Sintered Alloy Compact]

By using an Nd metal, a ferroboron alloy, a ferrocarbon alloy, and electrolytic iron (where each metal had a purity of 99% or more), the composition (without paying attention to Al, Si and Mn) of a sintered compact was adjusted to result in the compositions of Labels 1-A through 1-I shown in Table 1. These raw materials were melted and cast by a strip casting method, whereby raw material alloys in the form of flakes having a thickness of 0.2 to 0.4 mm were obtained. After each resultant raw material alloy in flake form was hydrogen-pulverized, it was subjected to a dehydrogenation treatment of heating to 550° C. in a vacuum and then cooling, whereby a coarse-pulverized powder was obtained. Next, to the resultant coarse-pulverized powder, zinc stearate was added as a lubricant in an amount of 0.04 mass % relative to 100 mass % of coarse-pulverized powder; after mixing, an airflow crusher (jet mill machine) was used to effect dry milling in a nitrogen jet, whereby a fine-pulverized powder (alloy powder) with a particle size D50 of 4 μm was obtained. Note that the particle size D50 is a central value of volume (volume median particle diameter) as obtained by a laser diffraction method by airflow dispersion technique. In order to adjust the C amount in the sintered compact, carbon black was added to part of the resultant fine-pulverized powder.

To the fine-pulverized powder, zinc stearate was added as a lubricant in an amount of 0.05 mass % relative to 100 mass % of fine-pulverized powder; after mixing, the fine-pulverized powder was pressed in a magnetic field, whereby a compact was obtained. As a pressing apparatus, a so-called orthogonal magnetic field pressing apparatus (transverse magnetic field pressing apparatus) was used, in which the direction of magnetic field application ran orthogonal to the pressurizing direction.

In a vacuum, the resultant compact was sintered for 4 hours at not less than 1000° C. and not more than 1040° C. (for each sample, a temperature was selected at which a sufficiently dense texture would result through sintering) and thereafter rapidly cooled, whereby an R1-T1-X based sintered alloy compact was obtained. Each resultant sintered compact had a density of 7.5 Mg/m³ or more. The components in the resultant sintered compacts and results of gas analysis (C (carbon amount)) thereof proved to be as shown in Table 1. The respective components in Table 1 were measured by using Inductively Coupled Plasma Optical Emission Spectroscopy (ICP-OES). The C (carbon amount) was measured by using a gas analyzer based on a combustion-infrared absorption method. The oxygen amount in each sintered compact was measured by a gas fusion infrared absorption method, which all indicated a value around 0.4 mass %. In Table 1, “[T1]/[X]” is a ratio (a/b) between: (a) a total of values resulting from dividing an analysis value (mass %) of each element composing T1 (including inevitable impurities, which in this Experimental Example are Al, Si and Mn) by the atomic weight of that element; and (b) a total of values resulting from dividing analysis values (mass %) of B and C by the atomic weights of these elements. The same also applies to all of the tables below. Note that each composition in Table 1 does not total to 100 mass %. This is because, as described earlier, a different method of analysis is employed for each component, and further because components other than the components listed in Table 1 (e.g., O (oxygen), N (nitrogen), and the like) exist. The same also applies to the other tables.

TABLE 1

| | R1-T1-X based sintered alloy compact composition (mass %) | | | | | | | | | |
|---|---|---|---|---|---|---|---|---|---|---|
| | R1 | | T1 | | | | X | | R1 | [T1]/ |
| Label | Nd | Pr | Fe | Al | Si | Mn | B | C | (mass %) | [X] |
| 1-A | 30.6 | 0.06 | 67.3 | 0.05 | 0.04 | 0.03 | 0.87 | 0.05 | 30.7 | 14.3 |
| 1-B | 30.1 | 0.10 | 68.1 | 0.06 | 0.05 | 0.04 | 0.90 | 0.05 | 30.2 | 14.0 |
| 1-C | 30.6 | 0.10 | 67.2 | 0.05 | 0.04 | 0.03 | 0.93 | 0.12 | 30.7 | 12.6 |
| 1-D | 30.5 | 0.10 | 67.2 | 0.05 | 0.04 | 0.04 | 1.00 | 0.05 | 30.6 | 12.5 |
| 1-E | 30.6 | 0.10 | 67.5 | 0.05 | 0.05 | 0.04 | 0.87 | 0.32 | 30.7 | 11.3 |
| 1-F | 30.6 | 0.51 | 67.4 | 0.10 | 0.05 | 0.02 | 0.88 | 0.09 | 31.1 | 13.6 |
| 1-G | 30.7 | 0.45 | 67.5 | 0.11 | 0.05 | 0.02 | 0.90 | 0.08 | 31.2 | 13.5 |
| 1-H | 30.5 | 0.52 | 67.3 | 0.11 | 0.05 | 0.02 | 0.92 | 0.08 | 31.0 | 13.2 |
| 1-I | 30.4 | 0.61 | 67.3 | 0.10 | 0.05 | 0.02 | 0.93 | 0.09 | 31.0 | 12.9 |

[Providing R2-Ga—Cu Based Alloy]

By using a Pr metal, a Ga metal, and a Cu metal (where each metal had a purity of 99% or more), the composition of an alloy was adjusted to result in the composition of Label 1-a shown in Table 2, and these raw materials were dissolved; thus, by a single roll rapid quenching method (melt spinning method), an alloy in ribbon or flake form was obtained. Using a mortar, the resultant alloy was pulverized in an argon ambient, and thereafter was passed through a sieve with an opening of 425 μm, thereby providing an R2-Ga—Cu based alloy. The composition of the resultant R2-Ga—Cu based alloy is shown in Table 2.

TABLE 2

| | R2—Ga—Cu | | | | |
|---|---|---|---|---|---|
| | based alloy | | | | |
| | composition | | | | |
| | (mol %) | | | R2 | [Cu]/ |
| Label | Pr | Ga | Cu | (mol %) | ([Ga] + [Cu]) |
| 1-a | 75 | 12.5 | 12.5 | 75 | 0.5 |

[Heat Treatment]

The R1-T1-X based sintered alloy compacts of Labels 1-A through 1-I in Table 1 were severed and cut into 2.4 mm×2.4 mm×2.4 mm cubes. Next, as shown in FIG. 2, in a processing container 3 made of niobium foils, the R2-Ga—Cu based alloy of Label 1-a shown in Table 2 was placed above and below each of the R1-T1-X based sintered alloy compacts of Labels 1-A through 1-I, in such a manner that mainly a face which was perpendicular to the alignment direction (i.e., the direction indicated by arrowheads in the figure) of the R1-T1-X based sintered alloy compact 1 was in contact with the R2-Ga—Cu based alloy 2.

Thereafter, in argon which was controlled to a reduced pressure of 200 Pa, a heat treatment was performed at the heat treatment temperature shown in Table 3 by using a tubular flow furnace, followed by cooling. In order to remove any thickened portion in the R2-Ga—Cu based alloy existing in the surface vicinity of each sample after the heat treatment, a surface grinder was used to cut 0.2 mm off the entire surface of each sample, whereby samples respectively in the form of a 2.0 mm×2.0 mm×2.0 mm cube (sintered R-T-B based magnet) were obtained.

[Sample Evaluations]

The resultant samples were set in a vibrating-sample magnetometer (VSM: VSM-5SC-10HF manufactured by TOEI INDUSTRY CO., LTD.) including a superconducting coil, and after applying a magnetic field up to 4 MA/m, the magnetic hysteresis curve of the sintered compact in the alignment direction was measured while sweeping the magnetic field to −4 MA/m. Values of coercivity (H_{cJ}) as obtained from the resultant hysteresis curves are shown in Table 3. It can be seen from Table 3 that high H_{cJ} is obtained when the molar ratio of [T1]/[X] in the R1-T1-X based sintered alloy compact is 13.0 or more, and a very high H_{cJ} exceeding 1900 kA/m is obtained at 14 or more in particular.

TABLE 3

| | fabrication conditions | | | | | | | | |
|---|---|---|---|---|---|---|---|---|---|
| | R1-T1-X based sintered | | | R2—Ga—Cu based alloy | | | | | |
| | alloy compact composition | | | composition | | | | | |
| sample | | R1 | [T1]/ | | R2 | [Cu]/ | heat | HcJ | |
| No. | Label | (mass %) | [X] | Label | (mol %) | ([Ga] + [Cu]) | treatment | (kA/m) | NOTES |
| 1-1 | 1-A | 30.7 | 14.3 | 1-a | 75 | 0.5 | 500° C. × | 2130 | Example of |
| | | | | | | | 4 hr | | Invention |
| 1-2 | 1-B | 30.2 | 14.0 | 1-a | 75 | 0.5 | 500° C. × | 1920 | Example of |
| | | | | | | | 4 hr | | Invention |
| 1-3 | 1-C | 30.7 | 12.6 | 1-a | 75 | 0.5 | 500° C. × | 350 | Comparative |
| | | | | | | | 4 hr | | Example |
| 1-4 | 1-D | 30.6 | 12.5 | 1-a | 75 | 0.5 | 500° C. × | 630 | Comparative |
| | | | | | | | 4 hr | | Example |
| 1-5 | 1-E | 30.7 | 11.3 | 1-a | 75 | 0.5 | 500° C. × | 80 | Comparative |
| | | | | | | | 4 hr | | Example |
| 1-6 | 1-F | 31.1 | 13.6 | 1-a | 75 | 0.5 | 500° C. × | 1925 | Example of |
| | | | | | | | 4 hr | | Invention |
| 1-7 | 1-G | 31.2 | 13.5 | 1-a | 75 | 0.5 | 500° C. × | 1930 | Example of |
| | | | | | | | 4 hr | | Invention |
| 1-8 | 1-H | 31.0 | 13.2 | 1-a | 75 | 0.5 | 500° C. × | 1895 | Example of |
| | | | | | | | 4 hr | | Invention |
| 1-9 | 1-I | 31.0 | 12.9 | 1-a | 75 | 0.5 | 500° C. × | 1028 | Comparative |
| | | | | | | | 4 hr | | Example |

Among the samples shown in Table 3, a cross section of Sample No. 1-1 (an example of the present invention) featuring the R1-T1-X based sintered alloy compact of Label 1-A having a molar ratio of [T1]/[X] of 13.0 or more and a cross section of Sample No. 1-4 (Comparative Example) featuring the R1-T1-X based sintered alloy compact of Label 1-D having a molar ratio of [T1]/[X] of less than 13.0 were observed with a scanning electron microscope (SEM: S4500 manufactured by Hitachi, Ltd.). The results indicated that thick intergranular grain boundaries of 100 nm or more had been formed in Sample No. 1-1 (an example of the present invention), from the vicinity of the magnet surface to the central portion of the magnet. On the other hand, in Sample No. 1-4 (Comparative Example), thick intergranular grain boundaries had only been formed in the vicinity of the magnet surface. Furthermore, a cross section of Sample No. 1-1, which is an example of the present invention, was analyzed by energy dispersive X-ray spectroscopy (EDX: HITS4800 manufactured by Hitachi, Ltd.), whereby Ga and Cu were detected also in the grain boundaries of the magnet central portion, a portion thereof being regarded as an R₆T₁₃Z phase containing Ga and Cu, based on its contents.

### Experimental Example 2

A plurality of R1-T1-X based sintered alloy compacts were produced by a similar method to Experimental Example 1, except that the composition (without paying attention to Al, Si and Mn) of a sintered compact was adjusted to result in the composition of Label 2-A shown in Table 4.

TABLE 4

| | R1-T1-X based sintered alloy compact composition (mass %) | | | | | | | | | |
|---|---|---|---|---|---|---|---|---|---|---|
| | R1 | | T1 | | | | X | | R1 | [T1]/ |
| Label | Nd | Pr | Fe | Al | Si | Mn | B | C | (mass %) | [X] |
| 2-A | 30.6 | 0.06 | 67.3 | 0.05 | 0.04 | 0.03 | 0.87 | 0.05 | 30.7 | 14.3 |

R2-Ga—Cu based alloys were produced by a similar method to Experimental Example 1, except for being adjusted so that the alloys had compositions Labels 2-a through 2-u shown in Table 5.

TABLE 5

| | R2—Ga—Cu based alloy composition (mol %) | | | | R2 | [Cu]/ |
|---|---|---|---|---|---|---|
| Label | Nd | Pr | Ga | Cu | (mol %) | ([Ga] + [Cu]) |
| 2-a | 0 | 100 | 0 | 0 | 100 | — |
| 2-b | 0 | 97 | 1.5 | 1.5 | 97 | 0.5 |
| 2-c | 0 | 95 | 2.5 | 2.5 | 95 | 0.5 |
| 2-d | 0 | 90 | 5 | 5 | 90 | 0.5 |
| 2-e | 0 | 85 | 7.5 | 7.5 | 85 | 0.5 |
| 2-f | 0 | 75 | 12.5 | 12.5 | 75 | 0.5 |
| 2-g | 0 | 70 | 15 | 15 | 70 | 0.5 |
| 2-h | 0 | 60 | 20 | 20 | 60 | 0.5 |
| 2-i | 0 | 50 | 25 | 25 | 50 | 0.5 |
| 2-j | 0 | 75 | 25 | 0 | 75 | 0 |
| 2-k | 0 | 75 | 22.5 | 2.5 | 75 | 0.1 |
| 2-l | 0 | 75 | 20 | 5 | 75 | 0.2 |
| 2-m | 0 | 75 | 17.5 | 7.5 | 75 | 0.3 |
| 2-n | 0 | 75 | 7.5 | 17.5 | 75 | 0.7 |
| 2-o | 0 | 75 | 5 | 20 | 75 | 0.8 |
| 2-p | 0 | 75 | 2.5 | 22.5 | 75 | 0.9 |
| 2-q | 0 | 75 | 0 | 25 | 75 | 1 |
| 2-r | 18.75 | 56.25 | 12.5 | 12.5 | 75 | 0.5 |
| 2-s | 56.25 | 18.75 | 12.5 | 12.5 | 75 | 0.5 |
| 2-t | 75 | 0 | 12.5 | 12.5 | 75 | 0.5 |
| 2-u | 0 | 90 | 1 | 9 | 90 | 0.9 |

After the plurality of R1-T1-X based sintered alloy compacts were processed similarly to Experimental Example 1, the R2-Ga—Cu based alloys of Labels 2-a through 2-u and the R1-T1-X based sintered alloy compact of Label 2-A were placed so as to be in contact with each other in a manner similar to Experimental Example 1, and a heat treatment and processing were performed similarly to Experimental Example 1 except for adopting the heat treatment temperatures shown in Table 6, whereby samples (sintered R-T-B based magnets) were obtained. The resultant samples were measured by a method similar to Experimental Example 1, thereby determining coercivity (H_{cJ}). The results are shown in Table 6. Note that Table 6 shows results of the conditions that provided the higher coercivity between a heat treatment at 500° C. and a heat treatment at 600° C. As indicated in Table 6, high H_{cJ} was obtained when R2 in the R2-Ga—Cu based alloy was not less than 65 mol % and not more than 95 mol % and the molar ratio of [Cu]/([Ga]+[Cu]) was not less than 0.1 and not more than 0.9. Regarding R2, high H_{cJ} was obtained when Pr accounted for 50 mol % or more in the entire R2 (compare Sample No. 2-18 against Sample Nos. 2-19 and 2-20); higher H_{cJ} was obtained when R2 was Pr alone (disregarding any other rare-earth elements at impurity levels); and highest H_{cJ} was obtained particularly when Label 2-f (Pr₇₅Ga_{12.5}Cu_{12.5} (mol %)) was used as the R2-Ga—Cu based alloy.

TABLE 6

| | fabrication conditions | | | | | | | | |
|---|---|---|---|---|---|---|---|---|---|
| | R1-T1-X based sintered | | | | | | | | |
| | alloy compact | | | R2—Ga—Cu based alloy | | | | | |
| sample | | R1 | [T1]/ | | R2 | [Cu]/ | heat | HcJ | |
| No. | Label | (mass %) | [X] | Label | (mol %) | ([Ga] + [Cu]) | treatment | (kA/m) | NOTES |
| 2-1 | 2-A | 30.7 | 14.3 | 2-a | 100 | — | 500° C. × | 43 | Comparative |
| | | | | | | | 4 h | | Example |
| 2-2 | 2-A | 30.7 | 14.3 | 2-b | 97 | 0.5 | 500° C. × | 127 | Comparative |
| | | | | | | | 4 h | | Example |
| 2-3 | 2-A | 30.7 | 14.3 | 2-c | 95 | 0.5 | 500° C. × | 1690 | Example of |
| | | | | | | | 4 h | | Invention |
| 2-4 | 2-A | 30.7 | 14.3 | 2-d | 90 | 0.5 | 500° C. × | 2048 | Example of |
| | | | | | | | 4 h | | Invention |
| 2-5 | 2-A | 30.7 | 14.3 | 2-e | 85 | 0.5 | 500° C. × | 2088 | Example of |
| | | | | | | | 4 h | | Invention |
| 2-6 | 2-A | 30.7 | 14.3 | 2-f | 75 | 0.5 | 500° C. × | 2130 | Example of |
| | | | | | | | 4 h | | Invention |
| 2-7 | 2-A | 30.7 | 14.3 | 2-g | 70 | 0.5 | 500° C. × | 2048 | Example of |
| | | | | | | | 4 h | | Invention |
| 2-8 | 2-A | 30.7 | 14.3 | 2-h | 60 | 0.5 | 600° C. × | 968 | Comparative |
| | | | | | | | 4 h | | Example |
| 2-9 | 2-A | 30.7 | 14.3 | 2-i | 50 | 0.5 | 500° C. × | 47 | Comparative |
| | | | | | | | 4 h | | Example |
| 2-10 | 2-A | 30.7 | 14.3 | 2-j | 75 | 0 | 600° C. × | 1329 | Comparative |
| | | | | | | | 4 h | | Example |
| 2-11 | 2-A | 30.7 | 14.3 | 2-k | 75 | 0.1 | 600° C. × | 1799 | Example of |
| | | | | | | | 4 h | | Invention |
| 2-12 | 2-A | 30.7 | 14.3 | 2-l | 75 | 0.2 | 600° C. × | 1910 | Example of |
| | | | | | | | 4 h | | Invention |
| 2-13 | 2-A | 30.7 | 14.3 | 2-m | 75 | 0.3 | 500° C. × | 2128 | Example of |
| | | | | | | | 4 h | | Invention |
| 2-14 | 2-A | 30.7 | 14.3 | 2-n | 75 | 0.7 | 500° C. × | 2008 | Example of |
| | | | | | | | 4 h | | Invention |
| 2-15 | 2-A | 30.7 | 14.3 | 2-o | 75 | 0.8 | 500° C. × | 1950 | Example of |
| | | | | | | | 4 h | | Invention |
| 2-16 | 2-A | 30.7 | 14.3 | 2-p | 75 | 0.9 | 500° C. × | 1849 | Example of |
| | | | | | | | 4 h | | Invention |
| 2-17 | 2-A | 30.7 | 14.3 | 2-q | 75 | 1 | 600° C. × | 888 | Comparative |
| | | | | | | | 4 h | | Example |
| 2-18 | 2-A | 30.7 | 14.3 | 2-r | 75 | 0.5 | 500° C. × | 2035 | Example of |
| | | | | | | | 4 h | | Invention |
| 2-19 | 2-A | 30.7 | 14.3 | 2-s | 75 | 0.5 | 500° C. × | 1889 | Example of |
| | | | | | | | 4 h | | Invention |
| 2-20 | 2-A | 30.7 | 14.3 | 2-t | 75 | 0.5 | 500° C. × | 1850 | Example of |
| | | | | | | | 4 h | | Invention |
| 2-21 | 2-A | 30.7 | 14.3 | 2-u | 90 | 0.9 | 500° C. × | 1768 | Example of |
| | | | | | | | 4 h | | Invention |

### Experimental Example 3

An R1-T1-X based sintered alloy compact was produced by a similar method to Experimental Example 1, except that the composition (without paying attention to Al, Si and Mn) of a sintered compact was adjusted to result in the composition of Label 3-A shown in Table 7.

TABLE 7

| | R1-T1-X based sintered alloy compact composition (mass %) | | | | | | | | | |
|---|---|---|---|---|---|---|---|---|---|---|
| | R1 | | T1 | | | | X | | R1 | [T1]/ |
| Label | Nd | Pr | Fe | Al | Si | Mn | B | C | (mass %) | [X] |
| 3-A | 30.6 | 0.06 | 67.3 | 0.05 | 0.04 | 0.03 | 0.87 | 0.05 | 30.7 | 14.3 |

An R2-Ga—Cu based alloy was produced by a similar method to Experimental Example 1 so that the alloy composition was the composition of Label 3-a shown in Table 8.

TABLE 8

| | R2—Ga—Cu based alloy composition (mol %) | | | | R2 | [Cu]/ |
|---|---|---|---|---|---|---|
| Label | Nd | Pr | Ga | Cu | (mol %) | ([Ga] + [Cu]) |
| 3-a | 0 | 75 | 12.5 | 12.5 | 75 | 0.5 |

After the R1-T1-X based sintered alloy compact was processed similarly to Experimental Example 1, the R2-Ga—Cu based alloy of Label 3-a and the R1-T1-X based sintered alloy compact of Label 3-A were placed so as to be in contact with each other in a manner similar to Experimental Example 1, and a heat treatment and processing were performed similarly to Experimental Example 1 except for adopting the heat treatment temperatures shown in Table 9, whereby samples (sintered R-T-B based magnets) were obtained. The resultant samples were measured by a method similar to Experimental Example 1, thereby determining coercivity (H_{cJ}). The results are shown in Table 9. As indicated in Table 9, high H_{cJ} was obtained when the heat treatment temperature was not less than 450° C. and not more than 600° C.

TABLE 9

| | fabrication conditions | | | | | | | | |
|---|---|---|---|---|---|---|---|---|---|
| | R1-T1-X based sintered | | | | | | | | |
| | alloy compact | | | R2—Ga—Cu based alloy | | | | | |
| sample | | R1 | [T1]/ | | R2 | [Cu]/ | heat | HcJ | |
| No. | Label | (mass %) | [X] | Label | (mol %) | ([Ga] + [Cu]) | treatment | (kA/m) | NOTES |
| 3-1 | 3-A | 30.7 | 14.3 | 3-a | 75 | 0.5 | 400° C. × | 38 | Comparative |
| | | | | | | | 4 h | | Example |
| 3-2 | 3-A | 30.7 | 14.3 | 3-a | 75 | 0.5 | 450° C. × | 1652 | Example of |
| | | | | | | | 4 h | | Invention |
| 3-3 | 3-A | 30.7 | 14.3 | 3-a | 75 | 0.5 | 500° C. × | 2130 | Example of |
| | | | | | | | 4 h | | Invention |
| 3-4 | 3-A | 30.7 | 14.3 | 3-a | 75 | 0.5 | 600° C. × | 1769 | Example of |
| | | | | | | | 4 h | | Invention |
| 3-5 | 3-A | 30.7 | 14.3 | 3-a | 75 | 0.5 | 700° C. × | 1420 | Comparative |
| | | | | | | | 4 h | | Example |
| 3-6 | 3-A | 30.7 | 14.3 | 3-a | 75 | 0.5 | 800° C. × | 1168 | Comparative |
| | | | | | | | 4 h | | Example |

### Experimental Example 4

An R1-T1-X based sintered alloy compact was produced by a similar method to Experimental Example 1, except that the composition (without paying attention to Al, Si and Mn) of a sintered compact was adjusted to result in the compositions of Labels 4-A through 4-D shown in Table 10.

TABLE 10

| | R1-T1-X based sintered alloy compact composition (mass %) | | | | | | | | | | |
|---|---|---|---|---|---|---|---|---|---|---|---|
| | R1 | | T1 | | | | | X | | R1 | [T1]/ |
| Label | Nd | Pr | Fe | Cu | Al | Si | Mn | B | C | (mass %) | [X] |
| 4-A | 30.8 | 0.61 | 66.6 | 0.12 | 0.07 | 0.05 | 0.02 | 0.87 | 0.08 | 31.4 | 13.7 |
| 4-B | 30.7 | 0.55 | 66.7 | 0.1 | 0.07 | 0.05 | 0.02 | 0.89 | 0.09 | 31.3 | 13.4 |
| 4-C | 30.6 | 0.51 | 66.8 | 0.15 | 0.08 | 0.05 | 0.02 | 0.92 | 0.08 | 31.1 | 13.1 |
| 4-D | 30.7 | 0.60 | 66.7 | 0.14 | 0.08 | 0.05 | 0.02 | 0.94 | 0.08 | 31.3 | 12.8 |

An R2-Ga—Cu based alloy was produced by a similar method to Experimental Example 1 so that the alloy composition was the composition of Label 4-a shown in Table 11.

TABLE 11

| | R2—Ga—Cu | | | | |
|---|---|---|---|---|---|
| | based alloy | | | | |
| | composition | | | | |
| | (mol %) | | | R2 | [Cu]/ |
| Label | Pr | Ga | Cu | (mol %) | ([Ga] + [Cu]) |
| 4-a | 75 | 12.5 | 12.5 | 75 | 0.5 |

After the R1-T1-X based sintered alloy compact was processed similarly to Experimental Example 1, the R2-Ga—Cu based alloy of Label 4-a and the R1-T1-X based sintered alloy compacts of Labels 4-A through 4-D were placed so as to be in contact with each other in a manner similar to Experimental Example 1, and a heat treatment and processing were performed similarly to Experimental Example 1 except for adopting the heat treatment temperature shown in Table 12, whereby samples (sintered R-T-B based magnets) were obtained. The resultant samples were measured by a method similar to Experimental Example 1, thereby determining coercivity (H_{cJ}). The results are shown in Table 12. It can be seen from Table 12 that, also in the R1-T1-X sintered compact works in which Cu are added, high H_{cJ} is obtained when the molar ratio of [T1]/[X] is 13.0 or more, and a very high H_{cJ} exceeding 1900 kA/m is obtained at 14 or more in particular.

TABLE 12

| | fabrication conditions | | | | | | | | |
|---|---|---|---|---|---|---|---|---|---|
| | R1-T1-X based sintered | | | | | | | | |
| | alloy compact | | | R2—Ga—Cu based alloy | | | | | |
| sample | | R1 | [T1]/ | | R2 | [Cu]/ | heat | HcJ | |
| No. | Label | (mass %) | [X] | Label | (mol %) | ([Ga] + [Cu]) | treatment | (kA/m) | NOTES |
| 4-1 | 4-A | 31.4 | 13.7 | 4-a | 75 | 0.5 | 500° C. × | 1955 | Example of |
| | | | | | | | 4 hr | | Invention |
| 4-2 | 4-B | 31.3 | 13.4 | 4-a | 75 | 0.5 | 500° C. × | 1954 | Example of |
| | | | | | | | 4 hr | | Invention |
| 4-3 | 4-C | 31.1 | 13.1 | 4-a | 75 | 0.5 | 500° C. × | 1892 | Example of |
| | | | | | | | 4 hr | | Invention |
| 4-4 | 4-D | 31.3 | 12.8 | 4-a | 75 | 0.5 | 500° C. × | 980 | Comparative |
| | | | | | | | 4 hr | | Example |

### Experimental Example 5

An R1-T1-X based sintered alloy compact was produced by a similar method to Experimental Example 1, except that the composition (without paying attention to Al, Si and Mn) of a sintered compact was adjusted to result in the compositions of Labels 5-A through 5-D shown in Table 13.

TABLE 13

| | R1-T1-X based sintered alloy compact composition (mass %) | | | | | | | | | | |
|---|---|---|---|---|---|---|---|---|---|---|---|
| | R1 | | T1 | | | | | X | | R1 | [T1]/ |
| Label | Nd | Pr | Fe | Co | Al | Si | Mn | B | C | (mass %) | [X] |
| 5-A | 30.7 | 0.55 | 66.1 | 0.98 | 0.08 | 0.05 | 0.02 | 0.87 | 0.09 | 31.4 | 13.7 |
| 5-B | 30.5 | 0.51 | 66.2 | 1.01 | 0.07 | 0.05 | 0.02 | 0.89 | 0.09 | 31.3 | 13.5 |
| 5-C | 30.8 | 0.49 | 66.0 | 0.99 | 0.07 | 0.05 | 0.02 | 0.92 | 0.08 | 31.1 | 13.0 |
| 5-D | 30.7 | 0.52 | 66.1 | 0.97 | 0.08 | 0.05 | 0.02 | 0.94 | 0.08 | 31.3 | 12.9 |

An R2-Ga—Cu based alloy was produced by a similar method to Experimental Example 1 so that the alloy composition was the composition of Label 5-a shown in Table 14.

TABLE 14

| | R2—Ga—Cu | | | | |
|---|---|---|---|---|---|
| | based alloy | | | | |
| | composition | | | | |
| | (mol %) | | | R2 | [Cu]/ |
| Label | Pr | Ga | Cu | (mol %) | ([Ga] + [Cu]) |
| 5-a | 75 | 12.5 | 12.5 | 75 | 0.5 |

After the R1-T1-X based sintered alloy compact was processed similarly to Experimental Example 1, the R2-Ga—Cu based alloy of Label 5-a and the R1-T1-X based sintered alloy compacts of Labels 5-A through 5-D were placed so as to be in contact with each other in a manner similar to Experimental Example 1, and a heat treatment and processing were performed similarly to Experimental Example 1 except for adopting the heat treatment temperature shown in Table 15, whereby samples (sintered R-T-B based magnets) were obtained. The resultant samples were measured by a method similar to Experimental Example 1, thereby determining coercivity (H_{cJ}). The results are shown in Table 15. It can be seen from Table 15 that, also in the R1-T1-X sintered compact works in which Co are added, high H_{cJ} is obtained when the molar ratio of [T1]/[X] is 13.0 or more, and a very high H_{cJ} exceeding 1900 kA/m is obtained at 14 or more in particular.

TABLE 15

| | fabrication conditions | | | | | | | | |
|---|---|---|---|---|---|---|---|---|---|
| | R1-T1-X based sintered | | | | | | | | |
| | alloy compact | | | R2-Ga—Cu based alloy | | | | | |
| | composition | | | composition | | | | | |
| sample | | R1 | [T1]/ | | R2 | [Cu]/ | | HcJ | |
| No. | Label | (mass %) | [X] | Label | (mol %) | ([Ga] + [Cu]) | heat treatment | (kA/m) | NOTES |
| 5-1 | 5-A | 31.4 | 13.7 | 5-a | 75 | 0.5 | 500° C. × 4 hr | 1988 | Example of |
| | | | | | | | | | Invention |
| 5-2 | 5-B | 31.3 | 13.5 | 5-a | 75 | 0.5 | 500° C. × 4 hr | 1939 | Example of |
| | | | | | | | | | Invention |
| 5-3 | 5-C | 31.1 | 13.0 | 5-a | 75 | 0.5 | 500° C. × 4 hr | 1838 | Example of |
| | | | | | | | | | Invention |
| 5-4 | 5-D | 31.3 | 12.9 | 5-a | 75 | 0.5 | 500° C. × 4 hr | 1097 | Comparative |
| | | | | | | | | | Example |

### Experimental Example 6

[Providing R1-T1-X Based Sintered Alloy Compact]

An R1-T1-X based sintered alloy compact was produced by a similar method to Experimental Example 1, except that the composition (without paying attention to Al, Si and Mn) of a sintered compact was adjusted to result in the composition of Label 6-A shown in Table 16.

TABLE 16

| | R1-T1-X based sintered alloy compact composition (mass %) | | | | | | | | | |
|---|---|---|---|---|---|---|---|---|---|---|
| | R1 | | T1 | | | | X | | R1 | |
| Label | Nd | Pr | Fe | Al | Si | Mn | B | C | (mass %) | [T1]/[X] |
| 6-A | 30.6 | 0.06 | 67.3 | 0.05 | 0.04 | 0.03 | 0.87 | 0.08 | 31.2 | 13.9 |

[Providing R2-Ga—Cu Based Alloy]

An R2-Ga—Cu based alloy was produced by a similar method to Experimental Example 1 so that the alloy composition was the composition of Label 6-a shown in Table 17.

TABLE 17

| | R2—Ga—Cu | | | | |
|---|---|---|---|---|---|
| | based alloy | | | | |
| | composition | | | | |
| | (mol %) | | | R2 | [Cu]/ |
| Label | Pr | Ga | Cu | (mol %) | ([Ga] + [Cu]) |
| 6-a | 75 | 12.5 | 12.5 | 75 | 0.5 |

[Heat Treatment]

The R1-T1-X based sintered alloy compact of Label 6-A in Table 16 was severed and cut into a 4.4 mm×4.4 mm×4.4 mm cube. Next, as shown in FIG. 2, in a processing container 3 made of niobium foils, the R2-Ga—Cu based alloy of Label 6-a shown in Table 17 was placed above and below the respective R1-T1-X based sintered alloy compact of Label 6-A, in such a manner that mainly a face which was perpendicular to the alignment direction (i.e., the direction indicated by arrowheads in the figure) of the R1-T1-X based sintered alloy compact 1 was in contact with the R2-Ga—Cu based alloy 2.

Thereafter, in argon which was controlled to a reduced pressure of 200 Pa, a heat treatment was performed at the heat treatment temperature shown in Table 18 by using a tubular flow furnace, followed by cooling. In order to remove any thickened portion in the R2-Ga—Cu based alloy existing in the surface vicinity of each sample after the heat treatment, a surface grinder was used to cut on the entire surface of each sample, whereby samples respectively in the form of a 4.0 mm×4.0 mm×4.0 mm cube (sintered R-T-B based magnet) were obtained.

[Sample Evaluations]

The resultant samples were set in a vibrating-sample magnetometer (VSM: VSM-5SC-10HF manufactured by TOEI INDUSTRY CO., LTD.) including a superconducting coil, and after applying a magnetic field up to 4 MA/m, the magnetic hysteresis curve of the sintered compact in the alignment direction was measured while sweeping the magnetic field to −4 MA/m. Values of coercivity (H_{cJ}) as obtained from the resultant hysteresis curves are shown in Table 18. It can be seen from Table 18 that, when the molar ratio of [T1]/[X] in the R1-T1-X based sintered alloy compact is 13.0 or more, high H_{cJ} is obtained even when a relatively large, 4.4 mm×4.4 mm×4.4 mm sintered compact is used.

TABLE 18

| | fabrication conditions | | | | | | | | |
|---|---|---|---|---|---|---|---|---|---|
| | R1-T1-X based sintered | | | | | | | | |
| | alloy compact | | | R2-Ga—Cu based alloy | | | | | |
| | composition | | | composition | | | | | |
| sample | | R1 | [T1]/ | | R2 | [Cu]/ | | HcJ | |
| No. | Label | (mass %) | [X] | Label | (mol %) | ([Ga] + [Cu]) | heat treatment | (kA/m) | NOTES |
| 6-1 | 6-A | 31.2 | 13.9 | 6-a | 75 | 0.5 | 500° C. × 4 hr | 2044 | Example of |
| | | | | | | | | | Invention |
| 6-2 | 6-A | 31.2 | 13.9 | 6-a | 75 | 0.5 | 500° C. × 8 hr | 2165 | Example of |
| | | | | | | | | | Invention |

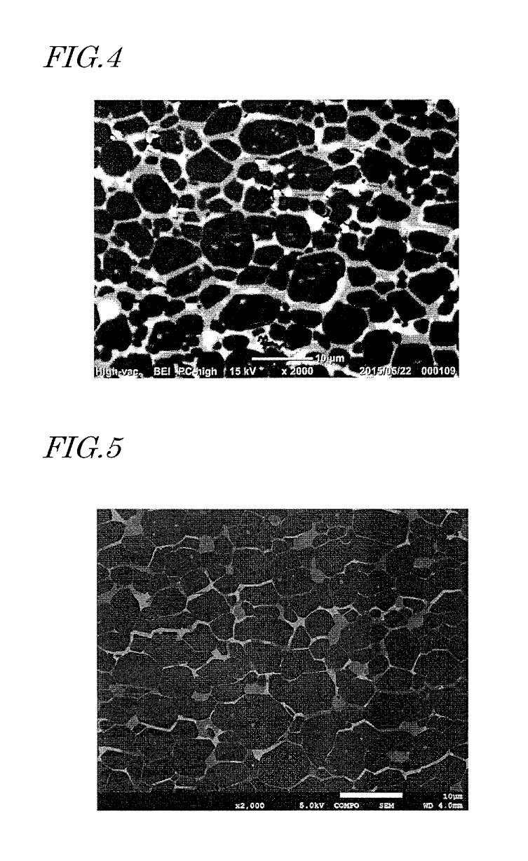

A cross section of Sample No. 6-1 as shown in Table 18 (an example of the present invention) was observed with a scanning electron microscope (SEM: JCM-6000 manufactured by JEOL, Ltd.). The results are shown in FIG. 3 and FIG. 4. FIG. 3 is a photograph showing the vicinity of the magnet surface of Sample No. 6-1 as observed with a scanning electron microscope. FIG. 4 is a photograph showing the magnet central portion. As is shown in FIG. 3 and FIG. 4, in Sample No. 6-1 (an example of the present invention), thick intergranular grain boundaries of 100 nm or more are formed from the vicinity of the magnet surface to the magnet central portion (i.e., a distance of 2.0 mm or more from the surface).

### Experimental Example 7

An R1-T1-X based sintered alloy compact was produced by a similar method to Experimental Example 1, except that the composition (without paying attention to Al, Si and Mn) of a sintered compact was adjusted to result in the composition of Label 7-A shown in Table 19.

TABLE 19

| | R1-T1-X based sintered alloy compact | | | | | | | | | | |
|---|---|---|---|---|---|---|---|---|---|---|---|
| | composition (mass %) | | | | | | | | | | |
| | R1 | | T1 | | | | | X | | R1 | [T1]/ |
| Label | Nd | Pr | Fe | Ga | Al | Si | Mn | B | C | (mass %) | [X] |
| 7-A | 30.7 | 0.55 | 66.5 | 0.20 | 0.08 | 0.05 | 0.02 | 0.87 | 0.05 | 31.3 | 14.2 |

An R2-Ga—Cu based alloy was produced by a similar method to Experimental Example 1 so that the alloy composition was the composition of Label 7-a shown in Table 20.

TABLE 20

| | R2—Ga—Cu | | | | |
|---|---|---|---|---|---|
| | based alloy | | | | |
| | composition | | | | |
| | (mol %) | | | R2 | [Cu]/ |
| Label | Pr | Ga | Cu | (mol %) | ([Ga] + [Cu]) |
| 7-a | 75 | 12.5 | 12.5 | 75 | 0.5 |

After the R1-T1-X based sintered alloy compact was processed similarly to Experimental Example 1, the R2-Ga—Cu based alloy of Label 7-a and the R1-T1-X based sintered alloy compact of Label 7-A were placed so as to be in contact with each other in a manner similar to Experimental Example 1, and a heat treatment and processing were performed similarly to Experimental Example 1 except for adopting the heat treatment temperature shown in Table 21, whereby a sample (sintered R-T-B based magnet) was obtained. The resultant sample was measured by a method similar to Experimental Example 1, thereby determining coercivity (H_{cJ}). The result is shown in Table 21. As shown in Table 21, also in the R1-T1-X sintered compact to which Ga is added, high H_{cJ} is obtained when the molar ratio of [T1]/[X] is 13.0 or more.

TABLE 21

| | fabrication conditions | | | | | | | | |
|---|---|---|---|---|---|---|---|---|---|
| | R1-T1-X based | | | | | | | | |
| | sintered alloy compact | | | R2-Ga—Cu based alloy | | | | | |
| sample | | R1 | [T1]/ | | R2 | [Cu]/ | | HcJ | |
| No. | Label | (mass %) | [X] | Label | (mol %) | ([Ga] + [Cu] | heat treatment | (kA/m) | NOTES |
| 7-1 | 7-A | 31.3 | 15.2 | 7-a | 75 | 0.5 | 500° C. × 4 h | 1976 | Example of |
| | | | | | | | | | Invention |

### Experimental Example 8

[Providing R1-T1-X Based Sintered Alloy Compact]

Respective elements were weighed so as to result in R1-T1-X based sintered alloy compacts having compositions of Labels 8-A through 8-C shown in Table 22 (without paying attention to Si and Mn), and thus alloys were produced by strip casting technique. Each resultant alloy was coarse-pulverized by a hydrogen pulverizing method to give a coarse-pulverized powder. Each coarse-pulverized powder was fine-pulverized in a jet mill, thus producing a fine-pulverized powder having a particle size D50 (central value of volume as obtained by a laser diffraction method by airflow dispersion technique) of 4 μm. In the fine-pulverized powder, 0.05 parts by mass of zinc stearate was added as a lubricant to 100 parts by mass of the fine-pulverized powder; after mixing, it was pressed in a magnetic field, whereby a compact was obtained. As a pressing apparatus, a so-called orthogonal magnetic field pressing apparatus (transverse magnetic field pressing apparatus) was used, in which the direction of magnetic field application ran orthogonal to the pressurizing direction. Each resultant compact was sintered by being retained at 1070° C. to 1090° C. depending on the composition for 4 hours in a vacuum, followed by cooling. Thereafter, it was retained at 800° C. for 2 hours in an argon ambient for a high-temperature heat treatment, and thereafter cooled to room temperature to give an R1-T1-X based sintered compact. The R1-T1-X based sintered alloy compact had a density of 7.5 Mg/m³ or more. Results of component analysis of these R1-T1-X based sintered alloy compacts are shown in Table 22. The respective components in Table 22 were measured by using Inductively Coupled Plasma Optical Emission Spectroscopy (ICP-OES). The C (carbon amount) was measured by using a gas analyzer based on a combustion-infrared absorption method. In Table 22, “[T1]/[X]” is a ratio (a/b) between: (a) a total of values resulting from dividing an analysis value (mass %) of each element composing T1 (including inevitable impurities, which in this Experimental Example are Si and Mn) by the atomic weight of that element; and (b) a total of values resulting from dividing analysis values (mass %) of B and C by the atomic weights of these elements. The same also applies to all of the tables below. Note that each composition in Table 22 does not total to 100 mass %. This is because, as described earlier, a different method of analysis is employed for each component, and further because components other than the components listed in Table 22 exist.

TABLE 22

| | R1-T1-X based sintered alloy | | | | | | | | | | |
|---|---|---|---|---|---|---|---|---|---|---|---|
| | compact composition (mass %) | | | | | | | | | R1 | |
| | R1 | | T1 | | | | | X | | (mass | [T1]/ |
| Label | Nd | Pr | Fe | Co | Cu | Ga | Al | B | C | %) | [X] |
| 8-A | 24.0 | 7.0 | 66.4 | 1.0 | 0.1 | 0.3 | 0.2 | 0.98 | 0.05 | 31.0 | 12.9 |
| 8-B | 24.0 | 7.0 | 68.8 | 1.0 | 0.1 | 0.0 | 0.2 | 0.87 | 0.05 | 31.0 | 14.9 |
| 8-C | 23.0 | 7.0 | 67.0 | 0.5 | 0.1 | 0.2 | 0.1 | 0.88 | 0.06 | 30.0 | 14.1 |

[Providing R2-Ga—Cu Based Alloy]

By using an Nd metal, a Pr metal, a Dy metal, a Ga metal, and a Cu metal (where each metal had a purity of 99% or more), the composition of an alloy was adjusted to result in the compositions of Labels 8-a through 8-d shown in Table 23, and these raw materials were dissolved; thus, by a single roll rapid quenching method (melt spinning method), an alloy in ribbon or flake form was obtained. Using a mortar, the resultant alloy was pulverized in an argon ambient, and thereafter was passed through a sieve with an opening of 425 μm, thereby providing an R2-Ga—Cu based alloy. The composition of the resultant R2-Ga—Cu based alloy is shown in Table 23.

TABLE 23

| | R2-Ga—Cu based alloy composition | | | | | | | |
|---|---|---|---|---|---|---|---|---|
| | (mol %) | | | | | | R2 | [Cu]/ |
| Label | Nd | Pr | Dy | Tb | Ga | Cu | (mol %) | ([Ga] + [Cu]) |
| 8-a | 0.0 | 76.0 | 0.0 | 0.0 | 12.4 | 11.6 | 76.0 | 0.5 |
| 8-b | 0.0 | 68.1 | 7.7 | 0.0 | 12.5 | 11.8 | 75.7 | 0.5 |
| 8-c | 8.6 | 59.3 | 0.0 | 7.8 | 12.5 | 11.8 | 67.9 | 0.5 |
| 8-d | 0.0 | 72.1 | 3.8 | 0.0 | 11.4 | 11.7 | 75.9 | 0.5 |

[Heat Treatment]

The R1-T1-X based sintered alloy compacts of Labels 8-A through 8-C in Table 1 were severed and cut into 7.4 mm×7.4 mm×7.4 mm cubes. Next, on the two faces of this sintered compact that were perpendicular to the alignment direction, the R2-Ga—Cu based alloy was spread at a ratio indicated in Table 24, relative to 100 parts by mass of the R1-T1-X based sintered alloy compact.

Thereafter, in argon which was controlled to a reduced pressure of 50 Pa, a heat treatment was performed at the heat treatment temperature shown in Table 24 by using a tubular flow furnace, followed by cooling. In order to remove any thickened portion in the R2-Ga—Cu based alloy existing in the surface vicinity of each sample after the heat treatment, a surface grinder was used to cut 0.2 mm off the entire surface of each sample, whereby samples respectively in the form of a 7.0 mm×7.0 mm×7.0 mm cube (sintered R-T-B based magnet) were obtained.

[Sample Evaluations]

After each resultant sample was magnetized in a pulsed magnetic field of 3.2 MA/m or more, its magnetic characteristics at room temperature and at 140° C. were measured with a pulse B-H tracer (VSM-5SC-10HF manufactured by TOEI INDUSTRY CO., LTD.). The resultant remanence (Bᵣ) and coercivity (H_{cJ}) values are shown in Table 24. As indicated by Table 24, even if the spread amount of R2-Ga—Cu based alloy is so very small as 0.25 parts by mass, a high H_{cJ} exceeding 1590 kA/m and a high Bᵣ exceeding 1.37T are reconciled in Samples 8-2 to 8-5, which satisfy the condition [T1]/[X]≧13.0 for the R1-T1-X based sintered compact, thus resulting in magnets with very high performances. On the other hand, high H_{cJ} is not obtained in Sample 8-1, which does not satisfy the condition [T1]/[X]≧13.0 for the R1-T1-X based sintered compact.

TABLE 24

| | fabrication conditions | | | | | | | | | | |
|---|---|---|---|---|---|---|---|---|---|---|---|
| | R1-T1-X based | | | | | | | | | | |
| | sintered alloy compact | | | R2-Ga—Cu based alloy | | | spread | | | | |
| sample | | R1 | [T1]/ | | R2 | [Cu]/ | amount | heat | Br | HcJ | |
| No. | Label | (mass %) | [X] | Label | (mol %) | ([Ga] + [Cu]) | [*] | treatment | (T) | (kA/m) | NOTES |
| 8-1 | 8-A | 31.0 | 12.9 | 8-a | 70.1 | 0.5 | 0.25 parts | 500° C. × 4 h | 1.40 | 900 | Comparative |
| | | | | | | | by mass | | | | Example |
| 8-2 | 8-B | 31.0 | 14.9 | 8-a | 70.1 | 0.5 | 0.25 parts | 500° C. × 4 h | 1.37 | 1640 | Example of |
| | | | | | | | by mass | | | | Invention |
| 8-3 | 8-C | 30.0 | 14.1 | 8-b | 69.8 | 0.5 | 0.25 parts | 500° C. × 4 h | 1.37 | 1690 | Example of |
| | | | | | | | by mass | | | | Invention |
| 8-4 | 8-C | 30.0 | 14.1 | 8-c | 69.7 | 0.5 | 0.25 parts | 500° C. × 4 h | 1.37 | 1750 | Example of |
| | | | | | | | by mass | | | | Invention |
| 8-5 | 8-C | 30.0 | 14.1 | 8-d | 69.9 | 0.5 | 0.25 parts | 500° C. × 4 h | 1.37 | 1590 | Example of |
| | | | | | | | by mass | | | | Invention |

[*] A spread amount of R-Ga—Cu alloy relative to 100 parts by mass of R1-T1-X based sintered alloy compact

### Experimental Example 9

[Providing R1-T1-X Based Sintered Alloy Compact]

An R1-T1-X based sintered alloy compact was produced by a similar method to Experimental Example 1, except that the composition (without paying attention to Al, Si and Mn) of a sintered compact was adjusted to result in the composition of Label 9-A shown in Table 25.

TABLE 25

| | R1-T1-X based sintered alloy compact composition (mass %) | | | | | | | | | | |
|---|---|---|---|---|---|---|---|---|---|---|---|
| | R1 | | T1 | | | | | X | | R1 | [T1]/ |
| Label | Nd | Pr | Fe | Ga | Al | Si | Mn | B | C | (mass %) | [X] |
| 9-A | 30.7 | 0.55 | 66.5 | 0.20 | 0.08 | 0.05 | 0.02 | 0.87 | 0.05 | 31.3 | 14.2 |

[Providing R2-Ga—Cu Based Alloy]

An R2-Ga—Cu based alloy was produced by a similar method to Experimental Example 1 so that the alloy composition was the composition of Label 9-a shown in Table 26.

TABLE 26

| | R2—Ga—Cu | | | | |
|---|---|---|---|---|---|
| | based alloy | | | | |
| | composition | | | | |
| | (mol %) | | | R2 | [Cu]/ |
| Label | Pr | Ga | Cu | (mol %) | ([Ga] + [Cu]) |
| 9-a | 75 | 12.5 | 12.5 | 75 | 0.5 |

The R1-T1-X based sintered alloy compact of Label 9-A in Table 25 was severed and cut into a 11.0 mm×10.0 mm×4.4 mm (alignment direction) rectangular solid. Next, as shown in FIG. 2, in a processing container 3 made of niobium foils, the R2-Ga—Cu based alloy of Label 9-a shown in Table 26 was placed above and below the respective R1-T1-X based sintered alloy compact of Label 9-A, in such a manner that mainly a face (which in this Experimental Example was a 11.0 mm×10.0 mm face) which was perpendicular to the alignment direction (i.e., the direction indicated by arrowheads in the figure) of the R1-T1-X based sintered alloy compact 1 was in contact with the R2-Ga—Cu based alloy 2.

Thereafter, in argon which was controlled to a reduced pressure of 200 Pa, it was retained at 540° C. for 4 hours by using a tubular flow furnace, after which the temperature was decreased at −10° C./minute to 500° C., at which it was retained for 1 hour, followed by cooling. Thereafter, it was processed by using an outer blade cutting machine and a surface grinder, whereby a sample in the form of a 4.0 mm×4.0 mm×4.0 mm cube (sintered R-T-B based magnet) was obtained.

[Sample Evaluations]

After the resultant sample was magnetized in a pulsed magnetic field of 3.2 MA/m, its magnetic characteristics at room temperature and at 140° C. were measured with a BH tracer. A coercivity (H_{cJ}) value as obtained from the resultant hysteresis curve is shown in Table 27. It can be seen from Table 27 that, when the molar ratio of [T1]/[X] in the R1-T1-X based sintered alloy compact is 13.0 or more, high H_{cJ} is obtained at room temperature. It can also be seen that a temperature coefficient β which is calculated from H_{cJ} at room temperature and H_{cJ} at 140° C. is better than that of a commonly-available sintered R-T-B based magnet at room temperature (β≈−0.50[%/° C.]) having a similar H_{cJ} but having Dy added thereto. Note that the aforementioned β is obtained as β=(H_{cJ}(140° C.)−H_{cJ}(23° C.)/(140−23)/H_{cJ}(23° C.)×100.

TABLE 27

fabrication conditions

| | R1-T1-X based | | | | | | | | | | |
|---|---|---|---|---|---|---|---|---|---|---|---|
| | sintered alloy | | | R2-Ga—Cu | | | | | | | |
| | compact composition | | | based alloy composition | | | | HcJ | HcJ | β | |
| sample | | R1 | [T1]/ | | R2 | [Cu]/ | | (kA/m) @ | (kA/m) @ | (23° C.- | |
| No. | Label | (mass %) | [X] | Label | (mol %) | ([Ga] + [Cu]) | heat treatment | 23° C. | 140° C. | 140° C.) | NOTES |
| 9-1 | 9-A | 31.1 | 14.2 | 9-a | 75 | 0.5 | 540° C. x 4 hr + | 1887 | 823 | −0.48 | Example of |
| | | | | | | | 500° C. + 1 hr | | | | Invention |

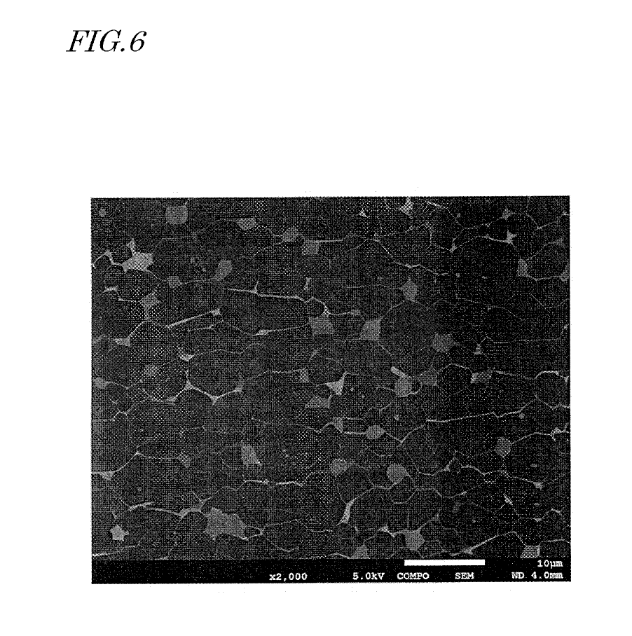

A cross section of the resultant sample was observed with a scanning electron microscope (SEM: JSM-7800F manufactured by JEOL, Ltd.). FIG. 5 shows a back scattered electron image of a cross section near the surface of the resultant sample, and FIG. 6 shows a back scattered electron image of a cross section of a central portion of the resultant sample. Thick intergranular grain boundaries of 100 nm or more had been formed, from the vicinity of the magnet surface to the central portion of the magnet. The composition of each phase with a different contrast in each of these fields of view was analyzed by energy dispersive X-ray spectroscopy (EDX: JED-2300 SD30 manufactured by JEOL, Ltd.), whereby Ga and Cu were detected from the grain boundary phase, a portion thereof being regarded as an R₆T₁₃Z phase containing Ga and/or Cu, based on its contents.

### Experimental Example 10

[Providing R1-T1-X Based Sintered Alloy Compact]

Respective elements were weighed so as to result in R1-T1-X based sintered alloy compacts having compositions of Labels 10-A through 10-F shown in Table 28 (without paying attention to Si and Mn), and thus alloys were produced by strip casting technique. Each resultant alloy was coarse-pulverized by a hydrogen pulverizing method to give a coarse-pulverized powder. Each coarse-pulverized powder was fine-pulverized in a jet mill, thus producing a fine-pulverized powder having a particle size D50 (central value of volume as obtained by a laser diffraction method by airflow dispersion technique) of 4 μm. In the fine-pulverized powder, 0.05 parts by mass of zinc stearate was added as a lubricant to 100 parts by mass of the fine-pulverized powder; after mixing, it was pressed in a magnetic field, whereby a compact was obtained. As a pressing apparatus, a so-called orthogonal magnetic field pressing apparatus (transverse magnetic field pressing apparatus) was used, in which the direction of magnetic field application ran orthogonal to the pressurizing direction. Each resultant compact was sintered by being retained at 1020° C. to 1060° C. depending on the composition for 4 hours in a vacuum, followed by rapid cooling, whereby an R1-T1-X based sintered alloy compact was obtained. The R1-T1-X based sintered alloy compact had a density of 7.5 Mg/m³ or more. Results of component analysis of these R1-T1-X based sintered alloy compacts are shown in Table 28. The respective components in Table 28 were measured by using Inductively Coupled Plasma Optical Emission Spectroscopy (ICP-OES). The C (carbon amount) was measured by using a gas analyzer based on a combustion-infrared absorption method. The oxygen amount in each sintered compact was measured by a gas fusion infrared absorption method, which all indicated a value around 0.1 mass %. In Table 28, “[T1]/[X]” is a ratio (a/b) between: (a) a total of values resulting from dividing an analysis value (mass %) of each element composing T1 (including inevitable impurities, which in this Experimental Example are Si and Mn) by the atomic weight of that element; and (b) a total of values resulting from dividing analysis values (mass %) of B and C by the atomic weights of these elements. The same also applies to all of the tables below. Note that each composition in Table 22 does not total to 100 mass %. This is because, as described earlier, a different method of analysis is employed for each component, and further because components other than the components listed in Table 28 exist.

TABLE 28

| | R1-T1-X based sintered alloy compact composition (mass %) | | | | | | | | | |
|---|---|---|---|---|---|---|---|---|---|---|
| | R1 | | T1 | | | | X | | R1 | [T1]/ |
| Label | Nd | Pr | Fe | Al | Si | Mn | B | C | (mass %) | [X] |
| 10-A | 29.8 | 0.18 | 68.3 | 0.02 | 0.06 | 0.02 | 0.88 | 0.10 | 30.0 | 13.8 |
| 10-B | 29.3 | 0.19 | 68.8 | 0.02 | 0.06 | 0.02 | 0.89 | 0.09 | 29.5 | 13.8 |
| 10-C | 28.5 | 0.19 | 69.9 | 0.04 | 0.05 | 0.02 | 0.90 | 0.07 | 28.7 | 14.1 |
| 10-D | 27.7 | 0.16 | 70.6 | 0.05 | 0.05 | 0.02 | 0.92 | 0.08 | 27.9 | 13.8 |
| 10-E | 26.0 | 0.15 | 72.4 | 0.04 | 0.05 | 0.02 | 0.93 | 0.08 | 26.2 | 14.0 |
| 10-F | 25.0 | 0.16 | 73.2 | 0.04 | 0.05 | 0.03 | 0.93 | 0.08 | 25.2 | 14.1 |

[Providing R2-Ga—Cu Based Alloy]

An R2-Ga—Cu based alloy was produced by a similar method to Experimental Example 1 so that the alloy composition was the composition of Label 10-a shown in Table 29.

TABLE 29

| | R2—Ga—Cu | | | | |
|---|---|---|---|---|---|
| | based alloy | | | | |
| | composition | | | | |
| | (mol %) | | | R2 | [Cu]/ |
| Label | Pr | Ga | Cu | (mol %) | ([Ga] + [Cu]) |
| 10-a | 75 | 12.5 | 12.5 | 75 | 0.5 |

The R1-T1-X based sintered alloy compacts of Labels 10-A through 10-F in Table 28 were severed and cut into 11.0 mm×10.0 mm×4.4 mm (alignment direction) rectangular solids. Next, as shown in FIG. 2, in a processing container 3 made of niobium foils, the R2-Ga—Cu based alloy of Label 10-a shown in Table 29 was placed above and below each of the R1-T1-X based sintered alloy compacts of Labels 10-A through 10-F, in such a manner that mainly a face (which in this Experimental Example was a 11.0 mm×10.0 mm face) which was perpendicular to the alignment direction (i.e., the direction indicated by arrowheads in the figure) of the R1-T1-X based sintered alloy compact 1 was in contact with the R2-Ga—Cu based alloy 2.

Thereafter, in argon which was controlled to a reduced pressure of 200 Pa, a heat treatment was performed at the heat treatment temperature shown in Table 30 by using a tubular flow furnace, followed by cooling. Thereafter, they were processed by using an outer blade cutting machine and a surface grinder, whereby samples respectively in the form of a 4.0 mm×4.0 mm×4.0 mm cube (sintered R-T-B based magnet) were obtained.

[Sample Evaluations]

After each resultant sample was magnetized in a pulsed magnetic field of 3.2 MA/m, its magnetic characteristics were measured with a BH tracer. Values of coercivity (H_{cJ}) as obtained from the resultant hysteresis curves are shown in Table 30. It can be seen from Table 30 that high H_{cJ} is obtained when R1 is 27 mass % or more and also the molar ratio of [T1]/[X] in the R1-T1-X based sintered alloy compact is 13.0 or more.

TABLE 30

| | fabrication conditions | | | | | | | | |
|---|---|---|---|---|---|---|---|---|---|
| | R1-T1-X based | | | | | | | | |
| | sintered alloy | | | R2-Ga—Cu based alloy | | | | | |
| | compact composition | | | composition | | | | | |
| sample | | R1 | [T1]/ | | R2 | [Cu]/ | heat | HcJ | |
| No. | Label | (mass %) | [X] | Label | (mol %) | ([Ga] + [Cu]) | treatment | (kA/m) | NOTES |
| 10-1 | 10-A | 30.0 | 13.8 | 10-a | 75 | 0.5 | 480° C. × 8 hr | 1967 | Example of |
| | | | | | | | | | Invention |
| 10-2 | 10-B | 29.5 | 13.8 | 10-a | 75 | 0.5 | 480° C. × 8 hr | 2036 | Example of |
| | | | | | | | | | Invention |
| 10-3 | 10-C | 28.7 | 14.1 | 10-a | 75 | 0.5 | 480° C. × 8 hr | 2002 | Example of |
| | | | | | | | | | Invention |
| 10-4 | 10-D | 27.9 | 13.8 | 10-a | 75 | 0.5 | 480° C. × 8 hr | 1976 | Example of |
| | | | | | | | | | Invention |
| 10-5 | 10-E | 26.2 | 14.0 | 10-a | 75 | 0.5 | 480° C. × 8 hr | 321 | Comparative |
| | | | | | | | | | Example |
| 10-6 | 10-F | 25.2 | 14.1 | 10-a | 75 | 0.5 | 480° C. × 8 hr | 112 | Comparative |
| | | | | | | | | | Example |

### Experimental Example 11

[Providing R1-T1-X Based Sintered Alloy Compact]

An R1-T1-X based sintered alloy compact was produced by a similar method to Experimental Example 1, except that the composition (without paying attention to Al, Si and Mn) of a sintered compact was adjusted to result in the composition of Label 11-A shown in Table 31.

TABLE 31

| | R1-T1-X based sintered alloy compact composition (mass %) | | | | | | | | | |
|---|---|---|---|---|---|---|---|---|---|---|
| | R1 | | T1 | | | | X | | R1 | [T1]/ |
| Label | Nd | Pr | Fe | Al | Si | Mn | B | C | (mass %) | [X] |
| 11-A | 30.6 | 0.06 | 67.3 | 0.05 | 0.04 | 0.03 | 0.87 | 0.08 | 31.2 | 13.9 |

[Providing R2-Ga—Cu Based Alloy]

By using a Pr metal, a Ga metal, a Cu metal, and an Fe metal (where each metal had a purity of 99% or more), the composition of an alloy was adjusted to result in the compositions of Labels 11-a through 11-c shown in Table 32, and these raw materials were dissolved; thus, by a single roll rapid quenching method (melt spinning method), an alloy in ribbon or flake form was obtained. Using a mortar, the resultant alloy was pulverized in an argon ambient, and thereafter was passed through a sieve with an opening of 425 μm, thereby providing an R2-Ga—Cu based alloy. The composition of the resultant R2-Ga—Cu based alloy is shown in Table 32.

TABLE 32

| | R2-Ga—Cu based alloy composition | | | | | |
|---|---|---|---|---|---|---|
| | (mol %) | | | | R2 | [Cu]/ |
| Label | Pr | Ga | Cu | Fe | (mol %) | ([Ga] + [Cu]) |
| 11-a | 73.9 | 12.3 | 12.3 | 1.5 | 73.9 | 0.5 |
| 11-b | 71.3 | 11.9 | 11.9 | 5.0 | 71.3 | 0.5 |
| 11-c | 67.5 | 11.3 | 11.3 | 10.0 | 67.5 | 0.5 |

[Heat Treatment]

The R1-T1-X based sintered alloy compact of Label 11-A in Table 31 was severed and cut into a 4.4 mm×4.4 mm×4.4 mm cube. Next, as shown in FIG. 2, in a processing container 3 made of niobium foils, the R2-Ga—Cu based alloys of Labels 11-a through 11-c shown in Table 32 were placed above and below the respective R1-T1-X based sintered alloy compact of Label 11-A, in such a manner that mainly a face which was perpendicular to the alignment direction (i.e., the direction indicated by arrowheads in the figure) of the R1-T1-X based sintered alloy compact 1 was in contact with the R2-Ga—Cu based alloy 2.

Thereafter, in argon which was controlled to a reduced pressure of 200 Pa, a heat treatment was performed at the heat treatment temperature shown in Table 18 by using a tubular flow furnace, followed by cooling. In order to remove any thickened portion in the R2-Ga—Cu based alloy existing in the surface vicinity of each sample after the heat treatment, a surface grinder was used to cut on the entire surface of each sample, whereby samples respectively in the form of a 4.0 mm×4.0 mm×4.0 mm cube (sintered R-T-B based magnet) were obtained.

[Sample Evaluations]

The resultant samples were set in a vibrating-sample magnetometer (VSM: VSM-5SC-10HF manufactured by TOEI INDUSTRY CO., LTD.) including a superconducting coil, and after applying a magnetic field up to 4 MA/m, the magnetic hysteresis curve of the sintered compact in the alignment direction was measured while sweeping the magnetic field to −4 MA/m. Values of coercivity (H_{cJ}) as obtained from the resultant hysteresis curves are shown in Table 33. It can be seen from Table 33 that high H_{cJ} is obtained even when Fe is contained in the R2-Ga—Cu based alloy. Moreover, as indicated by Sample Nos. 11-1 to 11-4, even higher H_{cJ} is obtained when the heat treatment temperature is in the range of not less than 480° C. and not more than 540° C.

TABLE 33

| | fabrication conditions | | | | | | | | |
|---|---|---|---|---|---|---|---|---|---|
| | R1-T1-X based | | | | | | | | |
| | sintered alloy | | | R2-Ga—Cu | | | | | |
| | compact composition | | | based alloy composition | | | | | |
| sample | | R1 | [T1]/ | | R2 | [Cu]/ | | HcJ | |
| No. | Label | (mass %) | [X] | Label | (mol %) | ([Ga] + [Cu]) | heat treatment | (kA/m) | NOTES |
| 11-1 | 11-A | 31.2 | 13.9 | 11-a | 73.9 | 0.5 | 460° C. × 8 h | 1784 | Example of |
| | | | | | | | | | Invention |
| 11-2 | 11-A | 31.2 | 13.9 | 11-a | 73.9 | 0.5 | 480° C. × 8 h | 1915 | Example of |
| | | | | | | | | | Invention |
| 11-3 | 11-A | 31.2 | 13.9 | 11-a | 73.9 | 0.5 | 520° C. × 8 h | 2031 | Example of |
| | | | | | | | | | Invention |
| 11-4 | 11-A | 31.2 | 13.9 | 11-a | 73.9 | 0.5 | 540° C. × 8 h | 1944 | Example of |
| | | | | | | | | | Invention |
| 11-5 | 11-A | 31.2 | 13.9 | 11-b | 71.3 | 0.5 | 520° C. × 8 h | 2020 | Example of |
| | | | | | | | | | Invention |
| 11-6 | 11-A | 31.2 | 13.9 | 11-c | 67.5 | 0.5 | 520° C. × 8 h | 2010 | Example of |
| | | | | | | | | | Invention |

In the specification of Japanese Patent Application No. 2015-150586 as filed (filing date: Jul. 30, 2015), which forms the basis of priority, the C (carbon amount) in 1-F to 1-I of Table 1, 4-A to 4-D of Table 10, 5-A to 5-D of Table 13, and 6-A of Table 16 were target values; but these have been corrected to measured values.

### INDUSTRIAL APPLICABILITY

A sintered R-T-B based magnet obtained according to the present invention can be suitably used in voice coil motors (VCM) of hard disk drives, various types of motors such as motors for electric vehicles (EV, HV, PHV, etc.) and motors for industrial equipment, home appliance products, and the like.

### REFERENCE SIGNS LIST

1 R1-T1-X based sintered alloy compact
2 R2-Ga—Cu based alloy
3 processing container

1: A method for producing a sintered R-T-B (where R is at least one rare-earth element which always includes Nd; T is at least one transition metal element which always includes Fe; and B is partially replaceable with C) based magnet, comprising:
a step of providing an R1-T1-X based sintered alloy compact, where R1 is at least one rare-earth element which always includes Nd, such that the R1-T1-X based sintered alloy compact contains R1 at a ratio of not less than 27 mass % and not more than 35 mass %; T1 is Fe, or Fe and M; M is one or more selected from the group consisting of Ga, Al, Si, Ti, V, Cr, Mn, Co, Ni, Cu, Zn, Ge, Zr, Nb, Mo and Ag; X is B, where B is partially replaceable by C; and a molar ratio of [T1]/[X] is not less than 13.0;
a step of providing an R2-Ga—Cu based alloy, where R2 is at least one rare-earth element which always includes Pr and/or Nd; the R2-Ga—Cu based alloy contains R2 at a ratio of not less than 65 mol % and not more than 95 mol %; and [Cu]/([Ga]+[Cu]) is not less than 0.1 and not more than 0.9 by mole ratio; and
a step of, while allowing at least a portion of the R2-Ga—Cu based alloy to be in contact with at least a portion of a surface of the R1-T1-X based sintered alloy compact, performing a heat treatment at a temperature which is not less than 450° C. and not greater than 600° C. in a vacuum or an inert gas ambient.

2: The method for producing a sintered R-T-B based magnet of claim 1, wherein T1 in the R1-T1-X comprises Fe and M, where M is one or more selected from the group consisting of Al, Si, Ti, V, Cr, Mn, Co, Ni, Cu, Zn, Ge, Zr, Nb, Mo and Ag.

3: The method for producing a sintered R-T-B based magnet of claim 1, wherein a molar ratio of [T1]/[X] in the R1-T1-X based sintered alloy compact is 13.6 or more.

4: The method for producing a sintered R-T-B based magnet of claim 1, wherein a molar ratio of [T1]/[X] in the R1-T1-X based sintered alloy compact is 14 or more.

5: The method for producing a sintered R-T-B based magnet of claim 1, wherein any heavy rare-earth element accounts for 1 mass % or less of the R1-T1-X based sintered alloy compact.

6: The method for producing a sintered R-T-B based magnet of claim 1, wherein the step of providing an R1-T1-X based sintered alloy compact comprises pulverizing a raw material alloy to a size of not less than 1 μm and not more than 10 μm, thereafter pressing the pulverized raw material alloy in a magnetic field, and performing sintering.

7: The method for producing a sintered R-T-B based magnet of claim 6, wherein the step of providing an R1-T1-X based sintered alloy compact comprises, after the sintering, performing a high-temperature heat treatment at a temperature which is above 600° C. and below a sintering temperature.

8: The method for producing a sintered R-T-B based magnet of claim 1, wherein the R2-Ga—Cu based alloy does not contain any heavy rare-earth element.

9: The method for producing a sintered R-T-B based magnet of claim 8, wherein Pr accounts for 50 mol % or more of the R2 in the R2-Ga—Cu based alloy.

10: The method for producing a sintered R-T-B based magnet of claim 8, wherein the R2 in the R2-Ga—Cu based alloy consists only of Pr (but is inclusive of inevitable impurities).

11: The method for producing a sintered R-T-B based magnet of claim 1, wherein some of the R2 in the R2-Ga—Cu based alloy is a heavy rare-earth element, the heavy rare-earth element being contained in an amount of 10 mol % or less of the entire R2-Ga—Cu based alloy.

12: The method for producing a sintered R-T-B based magnet of claim 11, wherein some of the R2 in the R2-Ga—Cu based alloy is a heavy rare-earth element, the heavy rare-earth element being contained in an amount of 5 mol % or less of the entire R2-Ga—Cu based alloy.

13: The method for producing a sintered R-T-B based magnet of claim 11, wherein, in the R2-Ga—Cu based alloy, some of the R2 is a heavy rare-earth element, and Pr accounts for 50 mol % or more of the entire R2 excluding the heavy rare-earth element.

14: The method for producing a sintered R-T-B based magnet of claim 11, wherein, in the R2-Ga—Cu based alloy, some of the R2 is a heavy rare-earth element, and Pr accounts for the entire R2 excluding the heavy rare-earth element (disregarding inevitable impurities).

15: The method for producing a sintered R-T-B based magnet of claim 1, wherein the temperature in the step of performing a heat treatment is not less than 480° C. and not more than 540° C.

16: The method for producing a sintered R-T-B based magnet of claim 1, wherein, in the step of performing a heat treatment, an R1₂T1₁₄X phase in the R1-T1-X based sintered alloy compact reacts with a liquid phase occurring from the R2-Ga—Cu based alloy to generate an R₆T₁₃Z phase (where Z always includes Ga and/or Cu) at least partially inside the sintered magnet.

17: The method for producing a sintered R-T-B based magnet of claim 1, wherein the step of performing a heat treatment comprises applying and/or spreading a powder of the R2-Ga—Cu based alloy on at least a portion of the surface of the R1-T1-X based sintered alloy compact to place the R2-Ga—Cu based alloy in contact with at least a portion of the surface of the R1-T1-X based sintered alloy compact.

18: The method for producing a sintered R-T-B based magnet of claim 17, wherein the powder of the R2-Ga—Cu based alloy to be spread and/or applied on the surface of the R1-T1-X based sintered alloy compact is in an amount of not less than 0.2 parts by mass and not more than 0.5 parts by mass, relative to 100 parts by mass of the R1-T1-X based sintered alloy compact.
